(19) United States
(12) Patent Application Publication
(10) Pub. No.: US 2024/0176468 A1
(43) Pub. Date: May 30, 2024

(54) DATA ANALYSIS SYSTEM, ANALYSIS DATA DISPLAY APPARATUS AND DATA DISPLAY METHOD IN DATA ANALYSIS SYSTEM

(71) Applicant: Shimadzu Corporation, Kyoto-shi (JP)

(72) Inventors: Ryuji SAWADA, Kyoto-shi (JP); Takeshi ONO, Kyoto-shi (JP)

(73) Assignee: Shimadzu Corporation, Kyoto-shi (JP)

(21) Appl. No.: 18/516,034

(22) Filed: Nov. 21, 2023

(30) Foreign Application Priority Data
Nov. 24, 2022 (JP) 2022-187623

(51) Int. Cl. G06F 3/0484; G06F 3/0482; G06F 18/231

(52) U.S. Cl. CPC G06F 3/0484; G06F 3/0482; G06F 18/231

(57) ABSTRACT

A data analysis system according to this invention includes a data acquirer, a storage configured to store to-be-analyzed data items and analysis modules linked with top hierarchical data items, an analyzer, a display, and a controller configured to direct the display to display the to-be-analyzed data items and/or the analysis modules that are linked with the top hierarchical data item(s) whose access right (s) is/are provided to a user in the hierarchical structure, and to exclude the to-be-analyzed data items and the analysis modules that are linked with the top hierarchical data item(s) whose access right (s) is/are not provided to the user from items to be displayed on the display.

### CROSS-REFERENCE TO RELATED APPLICATIONS

The related application number JP2022-187623, a data analysis system, an analysis data display apparatus and a data display method in a data analysis system, Nov. 24, 2022, SAWADA Ryuji, ONO Takeshi upon which this patent application is based are hereby incorporated by reference.

### BACKGROUND OF THE INVENTION

### Field of the Invention

The present invention relates to a data analysis system, an analysis data display apparatus and a data display method in a data analysis system, and particularly to a data analysis system, an analysis data display apparatus and a data display method in a data analysis system for displaying to-be-analyzed data items in a hierarchical structure.

### Description of the Background Art

Data analysis systems for displaying to-be-analyzed data in a hierarchical structure are known in the art. Such a data analysis system is disclosed in Japanese Patent Laid-Open Publication No. JP 2022-165665, for example.

The above Japanese Patent Laid-Open Publication No. JP 2022-165665 discloses a measurement image management system including a measurement device, a server, and user terminals. The above Japanese Patent Laid-Open Publication No. JP 2022-165665 discloses a configuration in which cell images captured by the measurement device are analyzed in the server in the measurement image management system. In addition, the server disclosed in the above Japanese Patent Laid-Open Publication No. JP 2022-165665 includes a data tree creation unit. The data tree creation unit is configured to create a data tree having a hierarchical structure by grouping captured cell images having common characteristics among a plurality of captured images into the same group. The measurement image management system disclosed in the above Japanese Patent Laid-Open Publication No. JP 2022-165665 is configured to display the data tree having a hierarchical structure on the user terminals.

Although not stated in the above Japanese Patent Laid-Open Publication No. JP 2022-165665, some users desire to commonly use to-be-analyzed data that is acquired by other users and analysis modules that are produced by other users as programs to analyze such to-be-analyzed data. Such to-be-analyzed data sometimes includes confidential data. To address this, it is conceivable to give access rights to users who are permitted to access such confidential data, and to manage permission to access the confidential data based on the access rights in order to prevent outsiders from accessing the confidential data. Because some analysis modules include confidential parameters, etc., such analysis modules are also necessarily managed based on such access rights. If access rights are managed both for the to-be-analyzed data and data to be used in analysis including the analysis modules, such access right management will be complicated. Also, such complicated access right management will prevent smooth common usage of the to-be-analyzed data and the data to be used in analysis including the analysis modules. For this reason, it is desired to commonly use data to be used in analysis while preventing complicated access right management of the data to be used in analysis.

### SUMMARY OF THE INVENTION

The present invention is intended to solve the above problem, and one object of the present invention is to provide a data analysis system, an analysis data display apparatus, and a data display method in a data analysis system capable of allowing users to commonly use data to be used in analysis while preventing complicated access right management of the data to be used in analysis.

In order to attain the aforementioned object, a data analysis system according to a first aspect of the present invention is a data analysis system for displaying to-be-analyzed data items as data to be analyzed in a hierarchical structure having a plurality of hierarchies and for analyzing the to-be-analyzed data items, the data analysis system including a data acquirer configured to acquire the to-be-analyzed data items; a storage configured to store the to-be-analyzed data items and analysis modules as programs to analyze the to-be-analyzed data items linked with top hierarchical data items that are data belonging to a top hierarchy of the hierarchical structure; an analyzer configured to analyze the to-be-analyzed data items by using the analysis modules; a display configured to display the to-be-analyzed data items and/or the analysis modules; and a controller configured to direct the display to display the to-be-analyzed data items and/or the analysis modules that are linked with the top hierarchical data item(s) whose access right (s) is/are provided to a user in the hierarchical structure from the to-be-analyzed data items and the analysis modules linked with the top hierarchical data item(s) that is/are stored in the storage, and to exclude the to-be-analyzed data items and the analysis modules that are linked with the top hierarchical data item(s) stored in the storage whose access right (s) is/are not provided to the user from items to be displayed on the display.

An analysis data display apparatus according to a second aspect of the present invention is an analysis data display apparatus for displaying to-be-analyzed data items as data to be analyzed in a hierarchical structure having a plurality of hierarchies, the analysis data display apparatus including a display configured to display the to-be-analyzed data items and/or analysis modules as programs to analyze the to-be-analyzed data items that are linked with top hierarchical data items that are data belonging to a top hierarchy of the hierarchical structure, wherein the display is configured to display the to-be-analyzed data items and/or the analysis modules that are linked with the top hierarchical data item(s) whose access right (s) is/are provided to a user in the hierarchical structure from the to-be-analyzed data items and the analysis modules that are linked with the top hierarchical data items, and to display neither the to-be-analyzed data items nor the analysis modules that are linked with the top hierarchical data item (s) whose access right (s) is/are not provided to the user.

A a data display method in a data analysis system according to a third aspect of the present invention is a data display method in a data analysis system for analyzing to-be-analyzed data items as data to be analyzed displayed in a hierarchical structure having a plurality of hierarchies, the data display method including a step of acquiring the to-be-analyzed data items; a step of storing the to-be-analyzed data items and analysis modules as programs to analyze the to-be-analyzed data items linked with top hierarchical data items that are data belonging to a top hierarchy; a step of providing each individual user with the access rights corresponding to the top hierarchical data item(s); a step of acquiring the to-be-analyzed data items and/or the analysis modules whose access right (s) is/are provided to a user from the to-be-analyzed data items and the analysis modules linked with the top hierarchical data items, which have been stored; and a step of displaying the to-be-analyzed data items and/or the analysis modules whose access rights are provided to the user in the hierarchical structure on a display.

In the data analysis system according to the first aspect, the analysis data display apparatus according to the second aspect, and the data display method in a data analysis system according to the third aspect, as discussed above, to-be-analyzed data items and analysis modules are stored with they being linked with top hierarchical data items. Because each individual user is provided with the access rights corresponding to the top hierarchical data item (s), access rights to the to-be-analyzed data items and the analysis modules that are linked with the top hierarchical data item(s) can be collectively provided to the user. Accordingly, it is possible to prevent complicated access right management of the to-be-analyzed data items and the analysis modules. Also, the to-be-analyzed data items and/or the analysis modules whose access rights are provided to the user is displayed in the hierarchical structure from the to-be-analyzed data items and the analysis modules linked with the top hierarchical data items. Accordingly, even if a user is neither a person who acquires the to-be-analyzed data items nor a a person who creates the analysis modules, the to-be-analyzed data items and/or the analysis modules whose access rights are provided to the user can be displayed for the user. As a result, a user can easily commonly use the to-be-analyzed data items and the analysis modules whose access rights are provided to the user. Therefore, it is possible to provide a data analysis system, an analysis data display apparatus, and a data display method in a data analysis system capable of allowing users to commonly use data to be used in analysis while preventing complicated access right management of the data to be used in analysis.

### BRIEF DESCRIPTION OF THE DRAWINGS

FIG. 1 is a schematic diagram entirely showing a configuration of a data analysis system according to one embodiment.

FIG. 2 is a schematic diagram illustrating a configuration according to the one embodiment in which to-be-analyzed data items and analysis modules linked with top hierarchical data items.

FIG. 3 is a schematic diagram illustrating a configuration in which the data analysis system according to the one embodiment displays top hierarchical data items, sub-hierarchical data items, and to-be-analyzed data items.

FIG. 4 is a schematic diagram illustrating a configuration in which some of the to-be-analyzed data items that are linked with one of the top hierarchical data items are hidden in the data analysis system according to the one embodiment.

FIG. 5 is a schematic diagram illustrating a configuration in which the data analysis system according to the one embodiment displays the top hierarchical data items, and analysis modules.

FIG. 6 is a schematic diagram illustrating a configuration in which some of the analysis modules that are linked with one of the top hierarchical data items are hidden in the data analysis system according to the one embodiment.

FIG. 7 shows a flowchart illustrating processing for providing each individual user with access rights to top hierarchical data items in the data analysis system according to the one embodiment.

FIG. 8 is a flowchart illustrating processing for displaying to-be-analyzed data items that are linked with a top hierarchical data item whose access right is provided to a user in the data analysis system according to the one embodiment.

FIG. 9 is a flowchart illustrating processing for displaying analysis modules that are linked with a top hierarchical data item whose access right is provided to a user in the data analysis system according to the one embodiment.

FIG. 10 is a flowchart illustrating processing for allowing a user to select whether to show or hide to-be-analyzed data items that are linked with a top hierarchical data item whose access right is provided to the user in the data analysis system according to the one embodiment.

FIG. 11 is a flowchart illustrating processing for allowing a user to select whether to show or hide analysis modules that are linked with a top hierarchical data item whose access right is provided to the user in the data analysis system according to the one embodiment.

FIG. 12 is a schematic diagram illustrating a configuration in which an analysis result is stored as input data by attaching an identifier indicating the input data to the analysis result in the data analysis system according to the one embodiment.

FIG. 13 is a schematic diagram illustrating a configuration in which further analysis is conducted by using an analysis result in the data analysis system according to the one embodiment.

FIG. 14 is a schematic diagram illustrating a configuration in which analysis results are listed with to-be-analyzed data items in the data analysis system according to the one embodiment.

FIG. 15 is a a flowchart illustrating processing of the data analysis system according to the one embodiment for attaching an identifier indicating input data to an analysis result and storing the analysis result in a storage.

FIG. 16 is a flowchart illustrating processing of the data analysis system according to the one embodiment for creating an analysis result that is linked with a top hierarchical data item whose access right is provided to a user.

### DESCRIPTION OF THE PREFERRED EMBODIMENT

Embodiments embodying the present invention will be described with reference to the drawings.

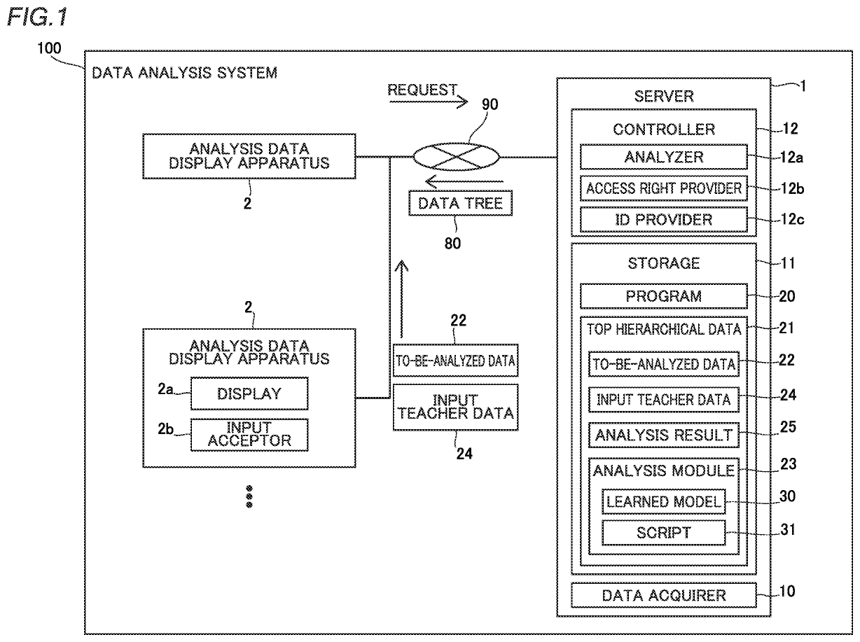

The following description describes a configuration of a data analysis system 100 according to one embodiment with reference to FIG. 1. The data analysis system 100 is a data analysis system for displaying to-be-analyzed data 22 as data to be analyzed in a hierarchical structure having a plurality of hierarchies. Also, the data analysis system 100 is a data analysis system for analyzing the to-be-analyzed data 22. For example, the data analysis system 100 analyzes images of cells as the to-be-analyzed data 22. The to-be-analyzed data 22 analyzed by the data analysis system 100 is not limited to images of cells.

### (Configuration of Data Analysis System)

As shown in FIG. 1, the data analysis system 100 includes a server 1 and analysis data display apparatuses 2.

The data analysis system 100 shown in FIG. 1 is illustratively constructed of an on-premises client-server model. The analysis data display apparatuses 2 serve as a client terminal in the data analysis system 100. The server 1 serves as a server for analyzing data in the data analysis system 100. The server 1 and the analysis data display apparatuses 2 can communicate with each other through a network 90. The server 1 performs various types of information processing in response to requests (processing requests) from the analysis data display apparatuses 2 operated by users. The server 1 analyzes the to-be-analyzed data 22 in accordance with the requests. The on-premises refers to an arrangement in which the server 1 and the analysis data display apparatuses 2 are located in the same facility.

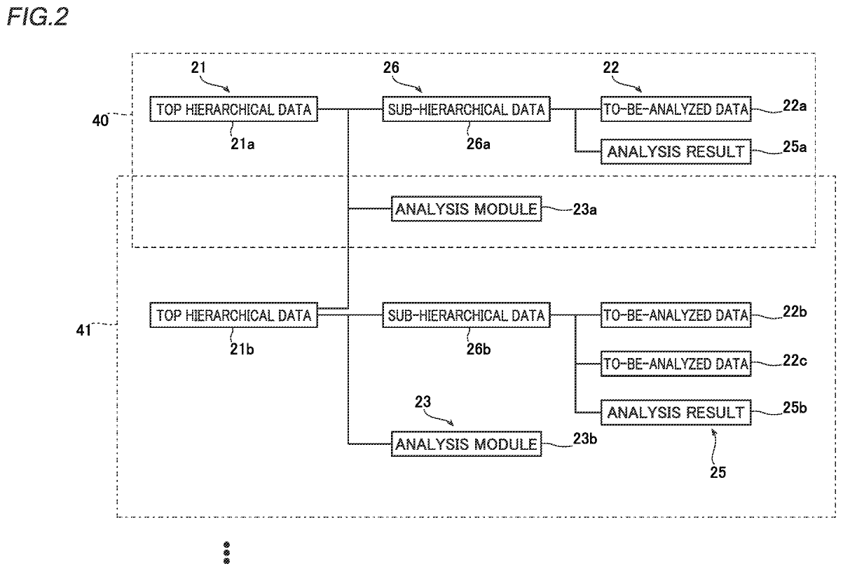

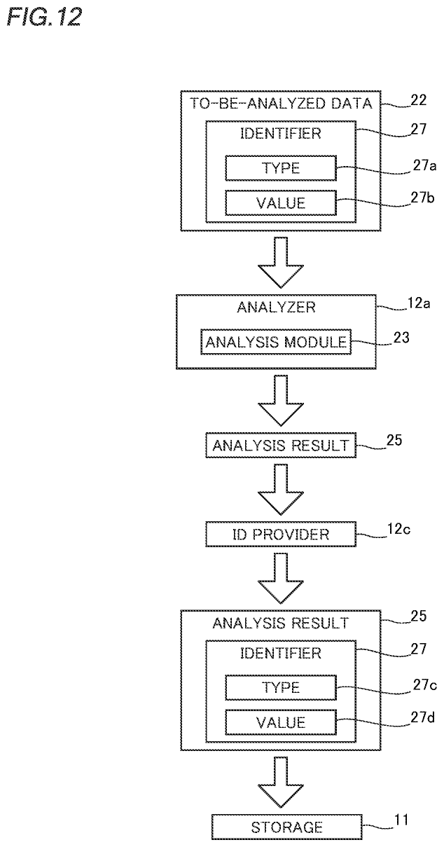

The server 1 is configured to create a data tree 80 showing the to-be-analyzed data 22 or an analysis module 23 as a program for analyzing the to-be-analyzed data item 22 in a hierarchical structure in accordance with the requests. The server 1 can send the created data tree 80 to the analysis data display apparatuses 2. The data tree 80 can be displayed on a display 2a included in the analysis data display apparatus 2. The data tree 80 is a virtual data tree indicating groups each of which includes two or more data items of the to-be-analyzed data item 22 and the analysis modules 23 that have a common grouping information attached to the to-be-analyzed data item 22 and the analysis modules 23. The grouping information includes top hierarchy data 21, sub-hierarchical data 26 (see FIG. 2), and an identifier 27 (see FIG. 12).

The network 90 connects the server 1 and the analysis data display apparatuses 2 to each other so that they can communicate with each other. The network 90 can be a local area network (LAN) configured in the facility, for example. The network 90 can be the Internet, for example. In a case in which the network 90 is the Internet, the data analysis system 100 can be a system configured in a cloud computing form.

The analysis data display apparatus 2 is an analysis data display apparatus for displaying to-be-analyzed data 22 as data to be analyzed in a hierarchical structure having a plurality of hierarchies. The analysis data display apparatus 2 is a so-called personal computer including a processor (not shown) and a storage (not shown). In addition, the analysis data display apparatus 2 includes the display 2a and an input acceptor 2b.

The display 2a configured to display the to-be-analyzed data 22 and/or the analysis modules 23. In this embodiment, the display 2a can display the to-be-analyzed data 22 as the data tree 80. For example, the display 2a is a display device such as an LCD monitor or an organic EL (Electro Luminescence) monitor. The display 2a may be a projector or head-mounted display.

The input acceptor 2b is configured to accept operating inputs from a user. For example, the input acceptor 2b is an input device including a computer mouse and a key-board. The input acceptor 2b may be a touch panel. The data analysis system 100 can includes one or more analysis data display apparatuses 2.

The server 1 includes a data acquirer 10, a storage 11 and a controller 12.

The data acquirer 10 is configured to acquire the to-be-analyzed data 22. Specifically, the data acquirer 10 is configured to acquire the to-be-analyzed data 22 provided from the analysis data display apparatuses 2 through the network 90. In this embodiment, the data acquirer 10 is configured to acquire input teacher data 24 provided from the analysis data display apparatuses 2 through the network 90. The input teacher data 24 is the training data used to generate a learned model 30. For example, the data acquirer 10 includes an input/output interface.

The storage 11 is configured to store various programs 20 to be executed by the controller 12. Also, the storage 11 is configured to store the to-be-analyzed data 22 and the analysis modules 23 linked with top hierarchical data 21, which is data belonging to a t top hierarchy of the hierarchical structure. Also, the storage 11 is configured to store the input teacher data 24 linked with the top hierarchical data 21. Also, the storage 11 is configured to store an analysis result 25, which is a result of analysis of the to-be-analyzed data 22 by the analysis module 23, linked with the top hierarchical data 21. The storage 11 includes an HDD (Hard Disk Drive) or a nonvolatile storage such as SSD (Solid State Drive), for example.

The analysis module 23 includes a learned model 30 that has learned to analyze the to-be-analyzed data 22. In this embodiment, the analysis module 23 further includes a script 31 for analysis of the to-be-analyzed data 22. The learned model 30 is generated, for example, by training a convolutional neural network (CNN) or a learning model including a convolutional neural network by using the input teacher data 24. The script 31, for example, includes a plurality of processing commands for analyzing the to-be-analyzed data 22. The script 31 includes a program that performs so-called rule-based analysis. The script 31 also includes a pre-processing program that applies processing to the to-be-analyzed data 22 before the to-be-analyzed data is analyzed by the learned model 30, and a post-processing program that applies processing to the analysis result 25 provided by the learned model 30.

The controller 12 is configured to analyze the to-be-analyzed data 22. Also, the controller 12 is configured to direct the display 2a to display the to-be-analyzed data 22 and the analysis module 23. Also, the controller 12 is configured to provide each individual user with access rights that are selected from access rights to a plurality of top hierarchical data items 21. Also, the controller 12 is configured to attach the identifier 27 (see FIG. 12) to the analysis result 25 acquired by analysis of the to-be-analyzed data 22. The controller 12 can include a CPU (Central Processing Unit), circuitry, a ROM (Read Only Memory), a RAM (Random Access Memory), a graphics processing unit (GPU), a field-programmable gate array (FPGA) configured for image processing, etc.

The controller 12 includes an analyzer 12a and a access right provider 12b and an ID (identifier) provider 12c. The analyzer 12a, the access right provider 12b and the ID provider 12c are constructed of software as functional blocks realized by executing the program 20 by the controller 12. The analyzer 12a, the access right provider 12b and the ID provider 12c may be constructed of hardware by providing dedicated processors (processing circuits).

The analyzer 12a is configured to analyze the to-be-analyzed data 22 by using the analysis module 23. The analyzer 12a can analyze the to-be-analyzed data 22 by using the analysis module 23 corresponding to analysis of the to-be-analyzed data 22. For example, in a case in which the to-be-analyzed data 22 is a cell image, the analyzer 12a uses the learned model 30 that is configured to determine whether a cell in the cell image is differentiated or keeps undifferentiated. The analyzer 12a can differently analyze to-be-analyzed data depending on the analysis module 23 (learned model 30 and/or script 31) used by the analyzer 12a.

The access right provider 12b is configured to provide each individual user with the access rights that are selected from access rights to the plurality of top hierarchical data items 21. In this embodiment, the access right provider 12b is configured to provide each individual user with the rights of access and usage of the to-be-analyzed data item 22, the input teacher data 24 and the analysis result 25 that are linked with the top hierarchy data 21 of the user. Also, the access right provider 12b is configured to provide each individual user with the rights of access and usage of the analysis module 23 that is linked with the top hierarchy data 21 of the user. The access rights to the top hierarchical data 21 includes a first access right that allows each individual user who is provided with the first access right to access and use data corresponding to the user, and a second access right that allows all user to access and use data corresponding to the all users. The access right provider 12b is configured to provide one of the first access right and the second access right to each of the plurality of top hierarchical data items 21.

The ID provider 12c is configured to provide the identifier 27 (see FIG. 12) to the analysis result 25. A configuration of the ID provider 12c that provides the identifier 27 to the analysis result 25 will be described later in detail.

Also, a configuration of the controller 12 that directs the display 2a to display the to-be-analyzed data 22 and the analysis module 23 will be described later.

<Linkage of to-be-Analyzed Data, Analysis Module and Analysis Result with Top Hierarchical Data>

FIG. 2 is a schematic diagram illustrating a configuration in which to-be-analyzed data items 22, analysis modules 23, analysis results 25 and sub-hierarchical data items 26 linked with top hierarchical data items 21.

In the exemplary configuration shown in FIG. 2, a to-be-analyzed data item 22a is linked with a top hierarchical data item 21a. Also, a sub-hierarchical data 26a is linked with the top hierarchy data 21a. Also, an analysis result 25a is linked with the top hierarchy data 21a. In the exemplary configuration shown in FIG. 2, the to-be-analyzed data item 22a and the analysis result 25a are linked with the top hierarchical data item 21a through the sub-hierarchical data item 26a. Also, an analysis module 23a is linked with the top hierarchy data 21a. In other words, a group 40 of data linked with the top hierarchical data item 21a includes the sub-hierarchical data item 26a, the to-be-analyzed data item 22a, the analysis result 25a and the analysis module 23a. The linkage with the top hierarchical data item 21 refers to attachment of information for reference with the top hierarchical data item 21 to the to-be-analyzed data item 22, etc. when the to-be-analyzed data item 22, etc. are stored in the storage 11. Information that represents data linked with top hierarchical data item 21 may be stored separately from the to-be-analyzed data item 22 in the storage 11 so that the to-be-analyzed data item 22, etc. may be linked with the top hierarchical data item 21.

In the exemplary configuration shown in FIG. 2, a to-be-analyzed data item 22b and a to-be-analyzed data item 22c are linked with a top hierarchical data item 21b. Also, an analysis result 25b is linked with the top hierarchy data 21b. Also, a sub-hierarchical data 26b is linked with the top hierarchy data 21a. In the exemplary configuration shown in FIG. 2, the to-be-analyzed data item 22b, the to-be-analyzed data item 22c and the analysis result 25b are linked with the top hierarchical data item 21b through the sub-hierarchical data item 26b. Also, an analysis module 23b is linked with the top hierarchy data 21b. In addition, the analysis module 23a is linked with the top hierarchy data 21b. In other words, a group 41 of data linked with the top hierarchical data item 21b includes the sub-hierarchical data item 26b, the to-be-analyzed data item 22b, the to-be-analyzed data item 22c, the analysis result 25b, the analysis module 23a and the analysis module 23b.

As shown in FIG. 2, the to-be-analyzed data item (s) 22 is/are linked with one top hierarchical data item 21 through sub-hierarchical data item 26. In other words, the to-be-analyzed data item(s) 22 is/are linked with the top hierarchical data item 21 in a one-to-one relationship.

Also, the analysis result 25 is linked with one top hierarchical data item 21 through sub-hierarchical data item 26. In other words, the analysis result 25 is linked with the top hierarchical data item 21 in a one-to-one relationship.

The analysis module 23 can be linked with two or more top hierarchical data items 21. In the exemplary configuration shown in FIG. 2, the analysis module 23a is linked with the top hierarchical data item 21a and the top hierarchical data item 21b. In other words, the analysis module 23 can be linked with the top hierarchical data item 21 in a one-to-many relationship. Note that the analysis module 23 may be linked with the top hierarchical data item 21 in a one-to-one relationship.

### <Displaying of Top Hierarchical Data, Sub-Hierarchical Data and To-Be-Analyzed Data>

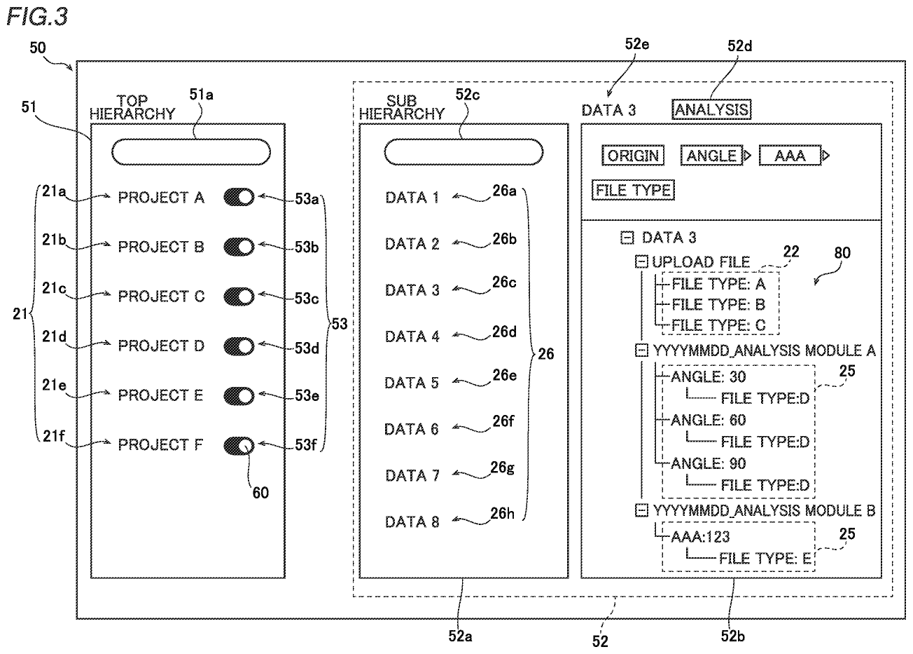

As shown in FIG. 3, the controller 12 (see FIG. 1) is configured to direct the display 2a (see FIG. 1) to display the to-be-analyzed data items 22 and/or the analysis modules 23 that are linked with the top hierarchical data items 21 whose access rights are provided to a user in the hierarchical structure from the to-be-analyzed data items 22 and the analysis modules 23 (see FIG. 2) linked with the top hierarchical data items 21 that are stored in the storage 11 (see FIG. 1).

In this embodiment, the controller 12 is configured to exclude the to-be-analyzed data items 22 and the analysis modules 23 that are linked with the top hierarchical data items 21 whose access rights are not provided to the user from items to be displayed on the display 2a. In other words, the display 2a is configured not to display the to-be-analyzed data items 22 and the analysis modules 23 that are linked with the top hierarchical data items 21 whose access rights are not provided to the user.

FIG. 3 is a schematic diagram illustrating an exemplary screen 50 in which the display 2a (see FIG. 1) displays the top hierarchical data items 21 and the to-be-analyzed data items 22. The display 2a includes a first display area 51 for displaying the top hierarchical data items 21. The controller 12 is configured to direct the display to list the top hierarchical data items 21 whose access rights are provided to the user in the first display area 51. In the exemplary screen shown in FIG. 3, six top hierarchical data items 21 of a top hierarchical data item 21a, a top hierarchical data item 21b, a top hierarchical data item 21c, a top hierarchical data item 21d, a top hierarchical data item 21e and a top hierarchical data item 21f are displayed in the first display area 51. The controller is configured to direct the display to selectively display only the top hierarchical data items 21 whose access rights are provided to the user in the first display area 51 from a number of the top hierarchical data items 21. In other words, in the exemplary screen shown in FIG. 3, the display selectively display the six top hierarchical data items 21 from a number of top hierarchical data items (more than six top hierarchical data items) 21.

Also, the controller 12 is configured to direct the display to display an input field 51a in the first display area 51. The controller 12 is configured to narrow the top hierarchical data items 21 to be displayed in the first display area 51 in accordance with an input instruction of the user accepted accepted in the input field 51a. In other words, the controller 12 can specify the top hierarchical data item 21 that are displayed in the first display area 51 from the top hierarchical data item 21 whose access rights are provided to the user. That is, the controller 12 is configured to retrieve the top hierarchical data item 21 to be displayed in the first display area 51 from the top hierarchical data item 21 whose access rights are provided to the user in accordance with the input instruction the user. To narrow the top hierarchical data items 21 refers to displaying of the top hierarchical data items 21 that are selected to be actually displayed in the first display area 51 from the top hierarchical data items 21 that are items to be displayed whose access rights are provided to the user in accordance with information provided by the input field 51a.

Also, in this embodiment, the controller 12 is configured to direct the display to list the to-be-analyzed data items 22 that are linked with a plurality of top hierarchical data items 21 that are displayed in the first display area 51. In this embodiment, the display 2a includes a second display area 52 for displaying the to-be-analyzed data items 22 that are linked with the plurality of top hierarchical data items 21. The controller 12 is configured to direct the display to list the to-be-analyzed data items 22 that are linked with the plurality of top hierarchical data items 21 that are displayed in the first display area 51 in the second display area 52.

In this embodiment, the to-be-analyzed data items 22 are displayed in a hierarchical structure on the display 2a.

The hierarchical structure includes at least three hierarchies. Also, the controller 12 is configured to direct the display to list the sub-hierarchical data item 26 that are linked with the plurality of top hierarchical data items 21 that are displayed in the first display area 51 in the second display area 52. In this embodiment, the display 2a is configured to display the sub-hierarchical data items 26 that are data linked with the top hierarchical data items 21 and belong to a hierarchy one level lower than the top hierarchy in the second display area 52, and the to-be-analyzed data items 22.

The second display area 52 includes a sub-hierarchical data display area 52a and a to-be-analyzed data display area The sub-hierarchical data display area 52a displays 52b. the sub-hierarchical data items 26. The to-be-analyzed data display area 52b displays the to-be-analyzed data items 22. As shown in FIG. 3, the sub-hierarchical data display area 52a is arranged between the first display area 51 and the to-be-analyzed data display area 52b.

In this embodiment, the controller 12 is configured to direct the display to collectively list a plurality of sub-hierarchical data items 26 that are linked with a plurality of different top hierarchical data items 21 that are displayed in the first display area 51 in the sub-hierarchical data display area 52a without distinction between items to be linked (top hierarchical data items 21). The controller 12 is configured to direct the display to display information on items to be linked (top hierarchical data items 21) for the plurality of sub-hierarchical data items 26 in the sub-hierarchical data display area 52a.

In the exemplary screen shown in FIG. 3, eight sub-hierarchical data items 26 of a sub-hierarchical data item 26a, a sub-hierarchical data item 26b, a sub-hierarchical data item 26c, a sub-hierarchical data item 26d, a sub-hierarchical data item 26e, a sub-hierarchical data item 26f, a sub-hierarchical data item 26g and a sub-hierarchical data item 26h are displayed in the sub-hierarchical data display area 52a. The sub-hierarchical data items 26 that are inked with the plurality of top hierarchical data items 21 are selected from more than eight sub-hierarchical data items 26 and in the sub-hierarchical data display area 52a.

The sub-hierarchical data item 26a is a sub-hierarchical data item 26 that is i linked with the top hierarchical data item 21a. The sub-hierarchical data item 26b is a sub-hierarchical data item 26 that is linked with the top hierarchical data item 21b. The sub-hierarchical data item 26c is a sub-hierarchical data item 26 that is linked with the top hierarchical data item 21c. The sub-hierarchical data item 26d is a sub-hierarchical data item 26 that is linked with the top hierarchical data item 21d. The sub-hierarchical data item 26e is a sub-hierarchical data item 26 that is linked with the top hierarchical data item 21e. The sub-hierarchical data item 26f is a sub-hierarchical data item 26 that is linked with the top hierarchical data item 21e. The sub-hierarchical data item 26g is a sub-hierarchical data item 26 that is linked with the top hierarchical data item 21f. The sub-hierarchical data item 26h is a sub-hierarchical data item 26 that is linked with the top hierarchical data item 21f.

<Selection of Whether To Show or Hide To-Be-Analyzed Data Items Linked with Top Hierarchical Data Items>

If the number of to-be-analyzed data items 22 that are linked with the plurality of top hierarchical data items 21 is large, the list of the to-be-analyzed data items 22 (sub-hierarchical data items 26) in the second display area 52 cannot be easily recognized (visibility of the list decreases). To address this, in this embodiment, the controller 12 is configured to switch between showing and hiding the to-be-analyzed data items 22 linked with the plurality of top hierarchical data items 21 whose access rights are provided to the user. In this embodiment, the controller 12 is configured to display operating buttons 53 aligned with the plurality of top hierarchical data items 21 in the first display area 51. The operating buttons 53 are buttons displayed to be operated by the user as a GUI (Graphical User Interface) to select, in accordance with a user input instruction accepted by the input acceptor 2b, the top hierarchical data items 21 with which the to-be-analyzed data items 22 to be shown are linked and the top hierarchical data items 21 with which the to-be-analyzed data items 22 to be hidden are linked from the top hierarchical data items 21 whose access rights are provided to the user. In an exemplary screen shown in FIG. 3, each of the top hierarchical data items 21a to 21f is provided with one of the operating buttons 53. In other words, in the exemplary screen shown in FIG. 3, the operating buttons 53 include six operating buttons of an operating button 53a, an operating button 53b, an operating button 53c, an operating button 53d, an operating button 53e and an operating button 53f.

The controller 12 is configured to switch between showing and hiding the to-be-analyzed data item 22 when a position of a button part 60 of the operating button 53 is changed by the user. In other words, the controller 12 directs the display to show the to-be-analyzed data item 22 when the button part 60 is operated to be positioned on a right side (hereinafter referred to as an “ON state”). Also, the controller 12 directs the display to hide the to-be-analyzed data 22 when the button part 60 is operated to be positioned on a left side (hereinafter referred to as an “OFF state”).

In this embodiment, the controller 12 is configured to direct the display to show all the to-be-analyzed data items 22 linked with the plurality of top hierarchical data items 21 whose access rights are provided to the user when the screen 50 is initially displayed. In other words, the controller 12 is configured to direct the display to display each operating button 53 with the button part 60 of the operating button 53 being in the ON state.

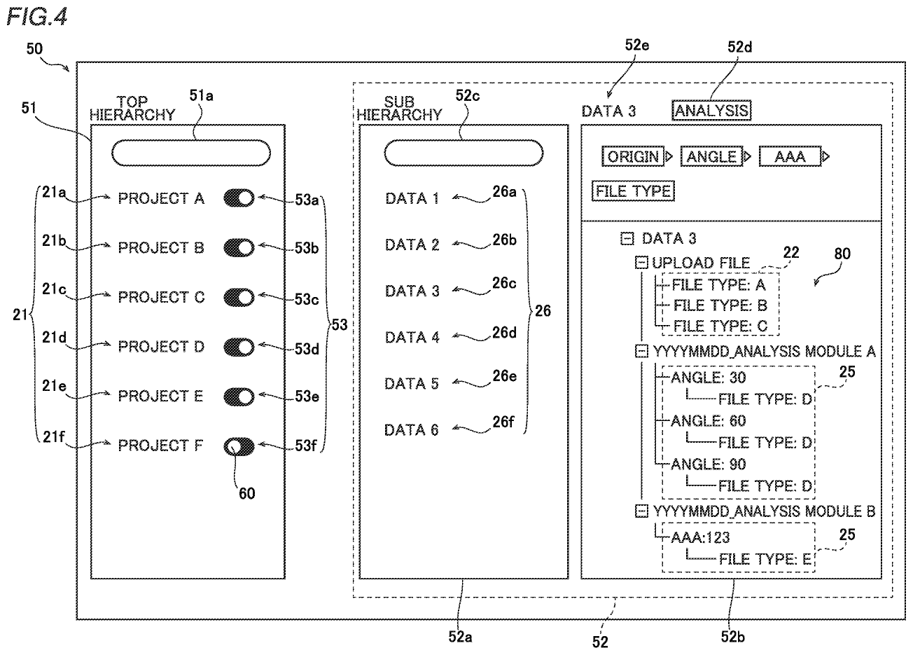

In an exemplary screen shown in FIG. 4, the to-be-analyzed data items 22 (see FIG. 2) that are linked with one of the plurality of top hierarchical data items 21 are hidden. Specifically, the to-be-analyzed data items 22 that are linked with the hierarchical data items 21f are hidden. As shown in FIG. 4, when the operating button 53f is operated to be brought into the OFF state by the user, the controller 12 (see FIG. 1) directs the display to hide the to-be-analyzed data items 22 that are linked with the top hierarchical data item 21f. Specifically, the controller 12 directs the display to hide the sub-hierarchical data item 26g (see FIG. 3) and the sub-hierarchical data item 26h (see FIG. 3), which are linked with the top hierarchical data item 21f. Correspondingly, the to-be-analyzed data items 22 that are linked with of the sub-hierarchical data items 26g, and the to-be-analyzed data items 22 that are linked with the sub-hierarchical data item 26h are hidden.

### <Narrowing of To-Be-Analyzed Data Items 22>

A configuration of the controller 12 according to this embodiment narrows the to-be-analyzed data item 22 is now described with reference back to FIG. 3. In this embodiment, the controller 12 is configured to direct the display to display an input field 52c for accepting a user input instruction in the second display area 52. Also, the controller 12 is configured to narrow the to-be-analyzed data items 22 that are linked with the top hierarchical data items 21 to be displayed in the second display area 52 in accordance with the user input instruction accepted in the input field 52c.

Specifically, the controller 12 is configured to direct the display to narrow the sub-hierarchical data items 26 to be displayed in the sub-hierarchical data display area 52a. The controller 12 is configured to direct the display to display the input field 52c in the sub-hierarchical data display area 52a. Accordingly, a user can selectively display desired sub-hierarchical data items 26 from a sub-hierarchical data item 26 that is linked with a top hierarchical data item 21 whose access right is provided to the user. In other words, the controller 12 is configured to retrieve the sub-hierarchical data item 26 that is linked with the top hierarchical data item 21 to be displayed in the second display area 52 in accordance with the user input instruction. The to-be-analyzed data items 22 that are linked with the sub-hierarchical data item 26 can be narrowed by retrieving the sub-hierarchical data item 26. To narrow the sub-hierarchical data items 26 refers to displaying of the sub-hierarchical data items 26 that are selected to be actually displayed in the second display area 52 from the sub-hierarchical data items 26 that are items to be displayed whose access rights are provided to the user in accordance with information provided by the input field 52c.

In the exemplary screen shown in FIG. 3, the to-be-analyzed data items 22 that are linked with the sub-hierarchical data item 26c are displayed in the to-be-analyzed data display area 52b. In this embodiment, the controller 12 is configured to direct the display to display the to-be-analyzed data items 22 in a form of a data tree 80. The to-be-analyzed data display area 52b includes an indication field 52e that displays the sub-hierarchical data item 26 that is selected by the user.

In this embodiment, the controller 12 is configured to direct the display to show the to-be-analyzed data items 22 that are linked with the sub-hierarchical data item 26 that is selected by the user in the data tree 80. In other words, the controller 12 is configured to direct the display to show the to-be-analyzed data items 22 that are linked with the sub-hierarchical data item 26 that is selected by the user from the sub-hierarchical data items 26 that are displayed in the sub-hierarchical data display area 52a.

In addition, an analysis button 52d is displayed on an upper side of the to-be-analyzed data display area 52b. The analysis button 52d is a press button displayed as a GUI. In a case in which a to-be-analyzed data item 22 displayed in the data tree 80 is selected, when the analysis button 52d is pressed, the controller 12 analyzes the selected to-be-analyzed data item 22. Specifically, in the case in which a to-be-analyzed data item 22 displayed is selected, when the analysis button 52d is pressed, the controller 12 directs the display to display a selection screen of the analysis module 23 (not shown). When an analysis module 23 is selected in the selection screen of the analysis module 23 and an instruction to execute analysis is provided, the controller 12 analyzes the selected to-be-analyzed data item 22 by using the selected analysis module 23. After the analysis is completed, an analysis result 25 is displayed in the same hierarchy as the selected to-be-analyzed data 22. A configuration of the controller 12 that directs the display to the analysis result 25 in the same hierarchy as the to-be-analyzed data item 22 will be described later in detail.

### <Displaying of Top Hierarchical Data Items and Analysis Modules>

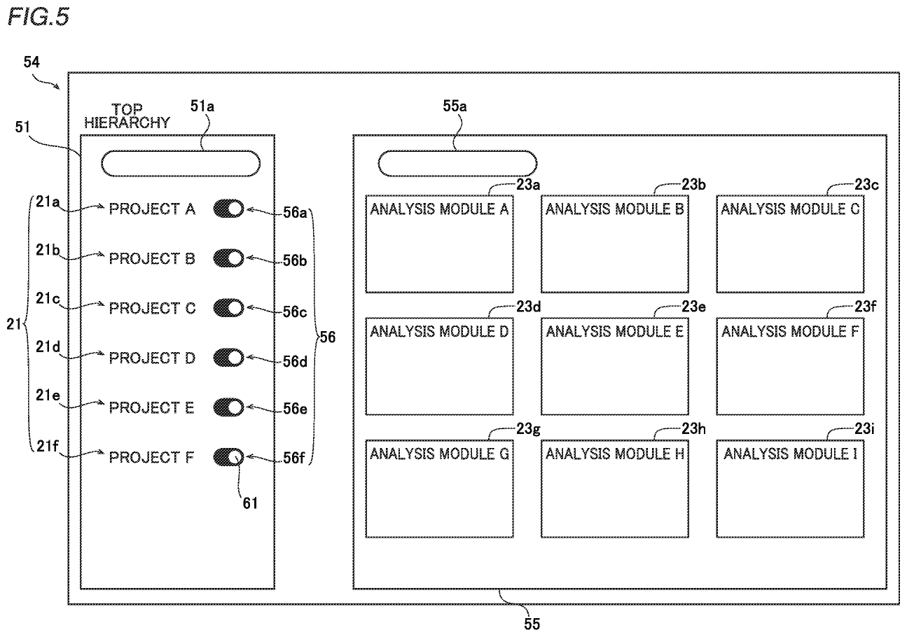

FIG. 5 is a schematic diagram illustrating an exemplary screen 54 in which the display 2a (see FIG. 1) displays the top hierarchical data items 21 and the analysis modules 23 (see FIG. 2). In this embodiment, the controller 12 is configured to direct the display to list the analysis modules 23 that are linked with a plurality of top hierarchical data items 21 that are displayed in the first display area 51. As shown in FIG. 5, the display 2a (see FIG. 1) includes a third display area 55 for displaying the analysis modules 23. The controller 12 is configured to direct the display to show the plurality of top hierarchical data items 21 whose access rights are provided to the user in the first display area 51, and to direct the display to list the analysis modules 23 that are linked with the plurality of top hierarchical data items 21 displayed in the first display area 51 in the third display area 55.

In this embodiment, the controller 12 is configured to direct the display to collectively list a plurality of analysis modules 23 that are linked with a plurality of different top hierarchical data items 21 that are displayed in the first display area 51 in the third display area 55 without distinction between items to be linked (top hierarchical data items 21). The controller 12 is configured to direct the display to display information on items to be linked (top hierarchical data items 21) for the plurality of analysis modules 23 in the third display area 55.

In the exemplary screen shown in FIG. 5, nine analysis modules 23 of an analysis module 23a, an analysis module 23b, an analysis module 23c, an analysis module 23d, an analysis module 23e, an analysis module 23f, an analysis module 23g, an analysis module 23h and an analysis module 23i are displayed in the third display area 55. The controller is configured to direct the display to selectively display only the analysis modules 23 that are linked with the top hierarchical data items 21 whose access rights are provided to the user from more than nine analysis modules 23 in the third display area 55.

In the exemplary screen shown in FIG. 5, the analysis module 23a is linked with the top hierarchical data item 21a. The analysis module 23a is additionally linked with the top hierarchical data item 21b. The analysis module 23b is linked with the top hierarchical data item 21b. The analysis module 23c is linked with the top hierarchical data item 21c. The analysis module 23d is linked with the top hierarchical data item 21d. The analysis module 23e is linked with the top hierarchical data item 21e. The analysis module 23f is linked with the top hierarchical data item 21e. The analysis module 23g is linked with the top hierarchical data item 21f. The analysis module 23h is linked with the top hierarchical data item 21f. The analysis module 23i is linked with the top hierarchical data item 21f.

One analysis module 23 can be linked with two or more top hierarchical data items 21. To address this, in this embodiment, the controller 12 is configured, in a case in which the analysis module 23 is linked with two or more of the top hierarchical data items 21, to direct the display 2a to display the analysis module 23 if all the access rights to the two or more of the top hierarchical data items 21 are provided to the user.

Contrary to this, the controller 12 is configured to exclude the analysis module 23 that is linked with the top hierarchical data items 21 from items to be displayed on the display 2a if at least one of the access rights to the two or more of the top hierarchical data items is not provided to the user.

Also, the controller 12 (see FIG. 1) is configured to direct the display to display an input field 55a in the third display area 55. Also, the controller 12 is configured to narrow the analysis modules 23 that are linked with the top hierarchical data items 21 to be displayed in the third display area 55 in accordance with the user input instruction accepted in the input field 55a. In other words, the controller 12 is configured to retrieve the analysis module 23 that is linked with the top hierarchical data item 21 to be displayed in the third display area 55 in accordance with the user input instruction.

<Selection of Whether To Show or Hide Analysis Modules Linked with Top Hierarchical Data Items>

As shown in FIG. 5, the controller 12 is configured to direct the display to display operating buttons 56 for switching between showing and hiding the analysis module 23 linked with the top hierarchical data item 21 also in the first display area 51 in the screen 54 for displaying the analysis modules 23. Each of the top hierarchical data items 21a to 21f is provided with one of the operating buttons 56. In other words, in the exemplary screen shown in FIG. 3, the operating buttons 56 include six operating buttons of an operating button 56a, an operating button 56b, an operating button 56c, an button 56d, an operating button 56e and an operating button 56f. A configuration of each operating button 56 is the same as that of the operating button 53 shown in FIG. 3 except that each operating button 56 has a button part 61, which has the same configuration as the button part 60, instead of the button part 60 (see FIG. 3), and its description is omitted.

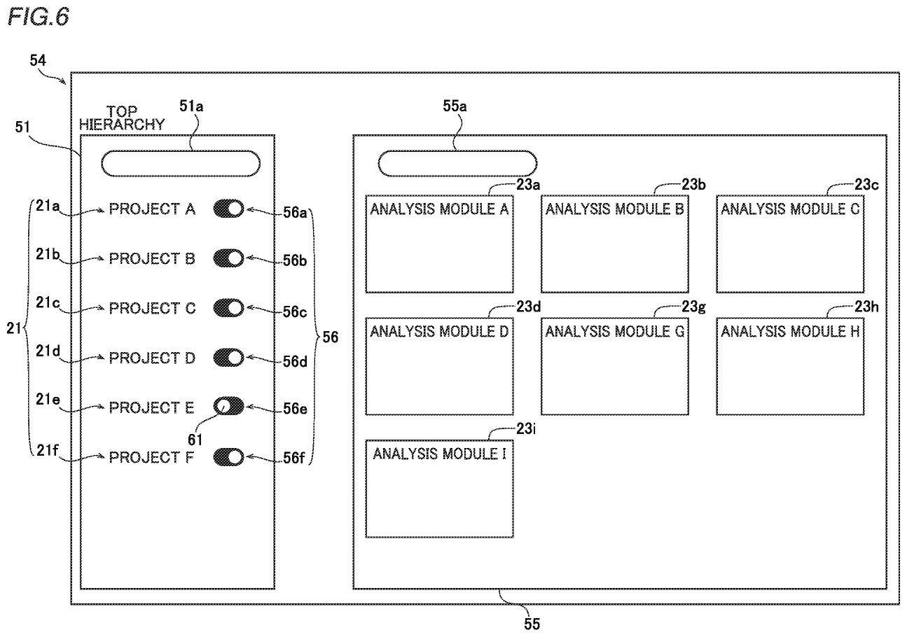

In an exemplary screen shown in FIG. 6, the analysis modules 23 (see FIG. 2) that are linked with one of the plurality of top hierarchical data items 21 are hidden. Specifically, the analysis modules 23 that are linked with the hierarchical data items 21e are hidden. As shown in FIG. 6, when the operating button 56e is operated to be brought into the OFF state by the user, the controller 12 (see FIG. 1) directs the display to hide the analysis modules 23 that are linked with the top hierarchical data item 21e. Specifically, the controller 12 directs the display to hide the analysis module 23e and the analysis module 23f, which are linked with the top hierarchical data item 21e.

### <Processing for Setting Access Rights to To-Be-Analyzed Data Items and Analysis Modules>

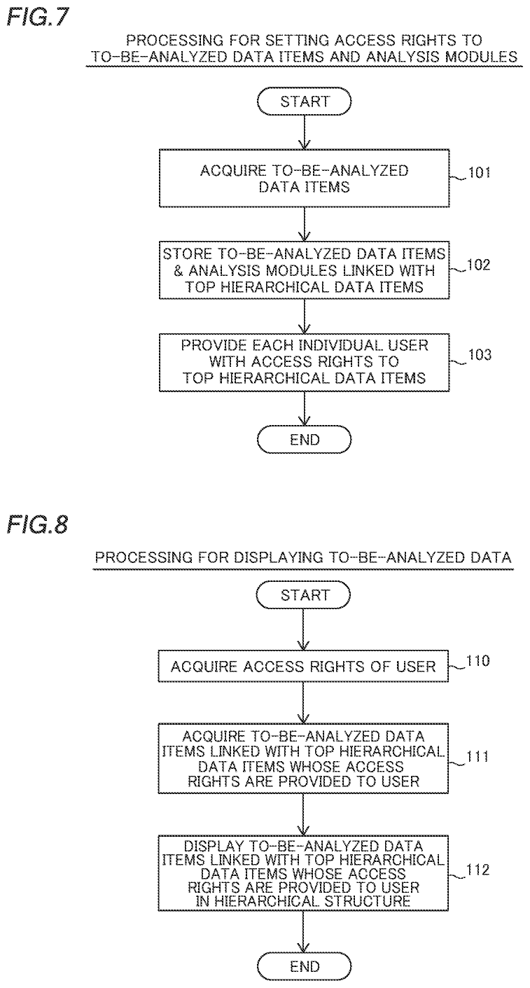

A configuration of the data analysis system 100 (see FIG. 1) that sets access rights to to-be-analyzed data items 22 (see FIG. 1) and analysis modules 23 (see FIG. 1) is now described with reference to FIG. 7.

In step 101, the data acquirer 10 (see FIG. 1) acquires to-be-analyzed data items 22. In this embodiment, the data acquirer 10 acquires the to-be-analyzed data items 22 from the analysis data display apparatus 2 (see FIG. 1) through the network 90 (see FIG. 1).

In step 102, the controller 12 (see FIG. 1) stores the to-be-analyzed data items 22 and analysis modules 23 as programs to analyze the to-be-analyzed data items 22 linked with top hierarchical data items 21, which are data belonging to a top hierarchy. In this embodiment, the controller 12 also stores sub-hierarchical data items 26 (see FIG. 12) linked with the top hierarchical data items 21 together with the to-be-analyzed data items 22 and the analysis modules 23 in the storage 11.

In step 103, the access right provider 12b (see FIG. 1) provides each individual user with access rights that are selected from access rights to top hierarchical data items 21. In other words, by providing each individual user with the access rights that are selected from the access rights to the top hierarchical data items 21 by using the access right provider 12b, access rights to the to-be-analyzed data items 22, the analysis modules 23, analysis results 25, the sub-hierarchical data items 26 that are linked with the top hierarchical data items 21 can be collectively provided to the user. After that, the procedure ends.

<Processing for Displaying To-Be-Analyzed Data Items Linked with Top Hierarchical Data Item Whose Access Right Is Provided to User>

A configuration of the controller 12 (see FIG. 1) that directs the display 2a (see FIG. 1) to display the to-be-analyzed data items 22 (see FIG. 2) linked with the top hierarchical data items 21 (see FIG. 2) whose access rights are provided to the user is now described with reference to FIG. 8.

In step 110, the controller 12 acquires access rights of a user. For example, the controller 12 acquires access rights of the user based on information on the user who logs in the data analysis system 100 (see FIG. 1). The access rights are previously provided to the user, and the access rights of the user are stored in the storage 11 (see FIG. 1).

In step 111, the controller 12 acquires the to-be-analyzed data items 22 that are linked with the top hierarchical data items 21 whose access rights are provided to the user from the to-be-analyzed data items 22 that are linked with the top hierarchical data items 21 and stored in the storage 11. In this embodiment, the controller 12 additionally acquires the sub-hierarchical data items 26 (see FIG. 12) that are linked with the top hierarchical data items 21 whose access rights are provided to the user.

In step 112, the controller 12 directs the display 2a to display the to-be-analyzed data items 22 in hierarchical structure on the display. Specifically, the controller 12 directs the display to display the top hierarchical data items 21 in the first display area 51 (see FIG. 3). Also, the controller 12 directs the display to display the sub-hierarchical data items 26 and the to-be-analyzed data items 22 in the second display area 52. In this embodiment, the controller 12 directs the display to display the sub-hierarchical data items 26 as a hierarchy under the top hierarchy data 21. In addition, the controller 12 directs the display to display the to-be-analyzed data items 22 in the data tree 80 (see FIG. 3) as a hierarchy under the sub-hierarchical data 26. After that, the procedure ends.

<Processing for Displaying Analysis Modules Linked with Top Hierarchical Data Item Whose Access Right Is Provided to User>

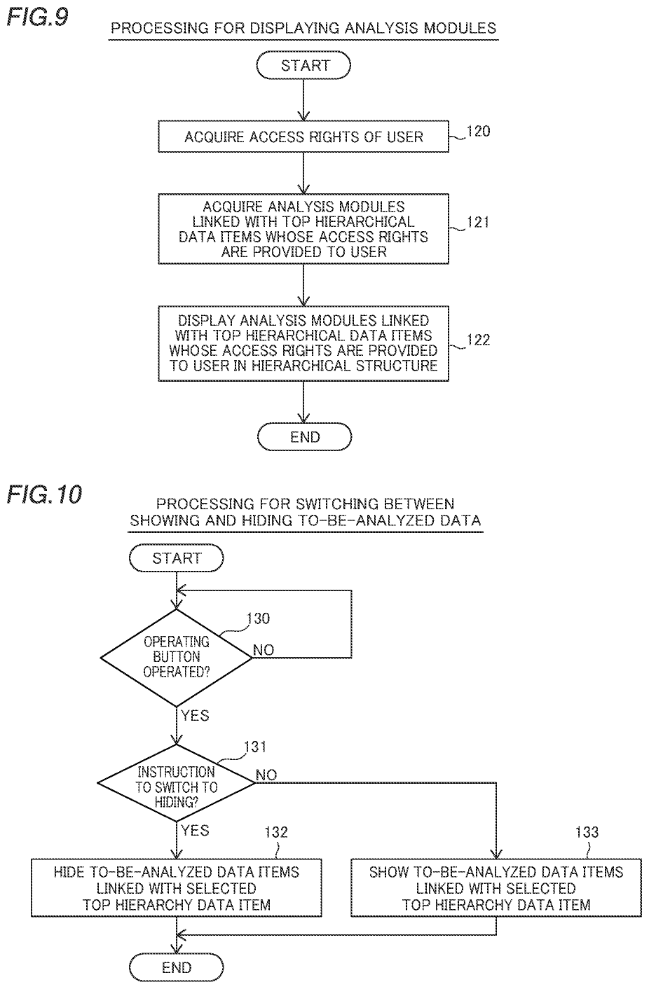

A configuration of the controller 12 (see FIG. 1) that directs the display 2a (see FIG. 1) to display the analysis modules 23 (see FIG. 2) linked with the top hierarchical data items 21 (see FIG. 2) whose access rights are provided to the user is now described with reference to FIG. 9.

In step 120, the controller 12 acquires access rights of a user. A configuration of the controller 12 acquires access rights of a user is the same process as step 110 shown in FIG. 8, and its description is omitted.

In step 121, the controller 12 acquires the analysis modules 23 that are linked with the top hierarchical data items 21 whose access rights are provided to the user from the analysis modules 23 that are linked with the top hierarchical data items 21 and stored in the storage 11.

In step 122, the controller 12 directs the display 2a to display the analysis modules 23 in a hierarchical structure on the display. Specifically, the controller 12 directs the display to display the top hierarchical data items 21 in the first display area 51 (see FIG. 5). Also, the controller 12 directs the display to display the analysis modules 23 linked with two or more the top hierarchical data items 21 in the third display area 55 (see FIG. 5). After that, the procedure ends.

### <Processing for Switching Between Showing and Hiding To-Be-Analyzed Data Item>

A configuration of the controller 12 (see FIG. 1) that switches between showing and hiding the to-be-analyzed data items 22 (see FIG. 1) is now described with reference to FIG. 10.

In step 130, the controller 12 determines whether the operating button 53 (see FIG. 3) is operated by a user. If the operating button 53 is not operated, the procedure repeats step 130. If the operating button 53 is operated, the procedure goes to step 131.

In step 131, the controller 12 determines whether the operation on the operating button 53 is an instruction to hide the to-be-analyzed data items 22. If the operation is an instruction to hide the to-be-analyzed data items 22, the procedure goes to step 132. If the operation is not an instruction to hide the to-be-analyzed data items 22, the procedure goes to step 133. In other words, if the operation is an instruction to show the to-be-analyzed data items 22, the procedure goes to step 133.

In step 132, the controller 12 directs the display to hide the to-be-analyzed data items 22 that are linked with the top hierarchical data item 21 (see FIG. 3) corresponding to the operated operating button 53. Specifically, the controller 12 hides the sub-hierarchical data items 26 (see FIG. 3) that are linked with the top hierarchical data item 21 corresponding to the operated operating button 53. After that, the procedure ends.

If the procedure goes from step 131 to step 133, the controller 12 directs the display to the to-be-analyzed data items 22 that are linked with the top hierarchical data item 21 corresponding to the operated operating button 53 in step 133. Specifically, the controller 12 directs the display to display the sub-hierarchical data items 26 that are linked with the top hierarchical data item 21 corresponding to the operated operating button 53. After that, the procedure ends.

### <Processing for Switching Between Showing and Hiding Analysis Modules>

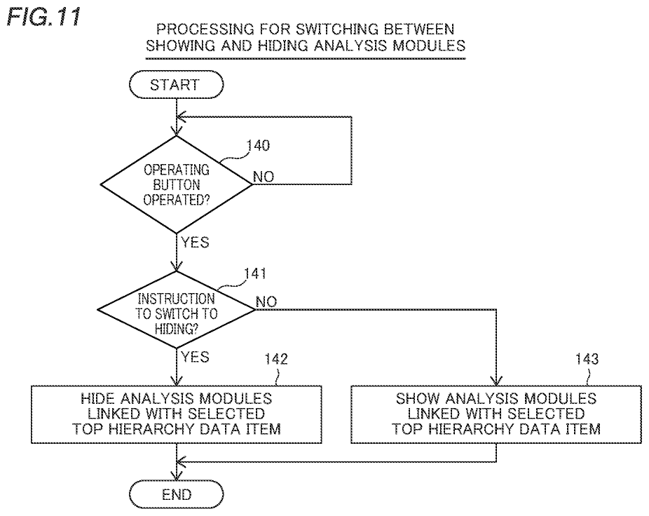

A configuration of the controller 12 (see FIG. 1) that switches between showing and hiding the analysis module 23 (see FIG. 1) is now described with reference to FIG. 11.

In step 140, the controller 12 determines whether the operating button 56 (see FIG. 5) is operated by a user. If the operating button 56 is not operated, the procedure repeats step 140. If the operating button 56 is operated, the procedure goes to step 141.

In step 141, the controller 12 determines whether the operation on the operating button 56 is an instruction to hide the analysis module 23. If the operation is an instruction to hide the analysis module 23, the procedure goes to step 142. If the operation is not an instruction to hide the analysis module 23, the procedure goes to step 143. In other words, if the operation is an instruction to show the analysis module 23, the procedure goes to step 143.

In step 142, the controller 12 directs the display to hide the analysis modules 23 that are linked with the top hierarchical data item 21 (see FIG. 5) corresponding to the operated operating button 56. After that, the procedure ends.

If the procedure goes from step 141 to step 143, the controller 12 directs the display to the analysis modules 23 that are linked with the top hierarchical data item 21 corresponding to the operated operating button 56 in step 143. After that, the procedure ends.

### <Attachment of Identifier to Analysis Result>

There is a need to display analysis results 25 (see FIG. 1), which are acquired by analyzing the to-be-analyzed data items 22 (see FIG. 1) by using the analyzer 12a (see FIG. 1), together with input teacher data items 24 (see FIG. 1) used to produce the to-be-analyzed data items 22 and/or the learned models 30 (see FIG. 1).

In this embodiment, the to-be-analyzed data items 22 and the input teacher data items 24 are uploaded by a user, and is stored in the storage 11. The storage 11 is configured to store the to-be-analyzed data items 22 and input teacher data items 24 that are attached with identifiers 27 (see FIG. 12) indicating input data corresponding to the to-be-analyzed data items 22 and the input teacher data items 24. The input data refers to a to-be-analyzed data (s) that will be analyzed when selected by a user. Also, the input data refers to a training data item item(s) that is/are used when the learned model 30 is produced. In other words, the input data can be the to-be-analyzed data item(s) 22 and the input teacher data item(s) 24.

As shown in FIG. 12, in order to display the analysis results 25 as input data on the display 2a (see FIG. 1), the controller 12 (see FIG. 1) is configured to direct the storage 11 to store the analysis results 25 as the input data by attaching the identifiers 27 indicating the input data to the analysis results 25 similar to the to-be-analyzed data items 22 and the input teacher data items 24.

The identifier 27 that includes a type 27a and a value 27b s attached to the to-be-analyzed data item 22. Specifically, the to-be-analyzed data item 22 is provided with the identifier 27 indicating the input data by the ID provider 12c and stored in the storage 11 when uploaded by the user. For example, “Origin” is provided as the type 27a of the identifier 27 to the to-be-analyzed data item 22. Also, “UploadFile” is provided as the value 27b of the identifier 27 to the to-be-analyzed data item 22. That is, in this embodiment, if “Origin” is attached as the type 27a to the to-be-analyzed data item, the to-be-analyzed data item is considered as the input data.

In a case in which the to-be-analyzed data 22 is analyzed in accordance with a user input instruction, the analyzer 12a analyzes the to-be-analyzed data item 22 by using the analysis module 23, and acquires the analysis result 25.

In this embodiment, the ID provider 12c attaches an identifier 27 that includes a type 27c and a value 27d to the analysis result 25. In addition, the ID provider 12c attaches “Origin” as the type 27c of the identifier 27 to the analysis result 25. In this case, the ID provider 12c provides a value based on an analysis data item and a name of the analysis module 23 that is used for the analysis, as the value 27d of the identifier 27 to the analysis result 25. Specifically, the ID provider 12c provides a string of alphabetic and numeric characters that is obtained by connecting the analysis data and time with the name of the analysis module 23 with an underscore character as the value 27d of identifier 27 to the analysis result.

Subsequently, the analysis result 25 provided with the identifier 27 including the type 27c and the value 27d is stored in the storage 11 by the controller 12. The analysis result 25 that is provided with “Origin” as the type 27c is also considered as the input data.

### <Displaying of Analysis Result and Further Analysis of Analysis Result>

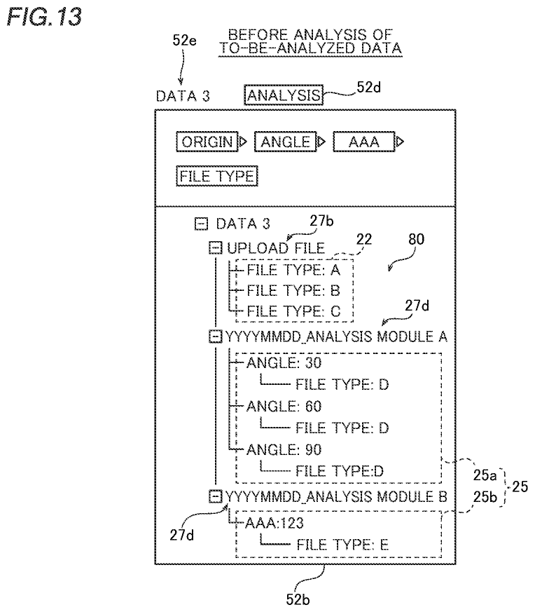

FIG. 13 is a schematic diagram showing an exemplary to-be-analyzed data display area 52b that lists the to-be-analyzed data items 22 that are uploaded by a user, and the analysis results 25. The controller 12 (see FIG. 1) is configured to direct the display 2a (see FIG. 1) to display the analysis results 25 that are linked with the top hierarchical data items 21 whose access rights are provided to the user from the analysis results 25 that are stored in the storage 11 (see FIG. 1). Specifically, the controller 12 is configured to direct the display to list the to-be-analyzed data items 22 and/or the input teacher data items 24, and the analysis results 25 in a bottom hierarchy of the hierarchical structure. In the to-be-analyzed data display area shown in FIG. 13, the to-be-analyzed data items 22 and the analysis results 25 are listed in the bottom hierarchy of the hierarchical structure.

In the to-be-analyzed data display area shown in FIG. 13, the controller 12 is configured to direct the display to display the to-be-analyzed data items 22 and the analysis results 25a and analysis results 25b that are linked with the sub-hierarchical data item 26c (see FIG. 3) in the data tree 80. The controller 12 is configured to direct the display to display the to-be-analyzed data items 22 and the analysis results 25 discriminatively from each other as shown in the data tree 80. Specifically, the controller 12 is configured to direct the display to display the value 27b of the identifier 27 (see FIG. 12) of the to-be-analyzed data items 22 and the values 27d of the identifier 27 of the analysis results 25 whereby displaying the to-be-analyzed data items 22 and the analysis results 25 discriminatively from each other. Accordingly, the user can easily discriminate the to-be-analyzed data items 22 and the analysis results 25, which are listed information, from each other.

In this embodiment, the controller 12 is configured to exclude the analysis modules 25 that are linked with the top hierarchical data items 21 whose access rights are not provided to the user from items to be displayed on the display 2a. As a result, the display 2a does not display the analysis modules 25 that are linked with the top hierarchical data items 21 whose access rights are not provided to the user.

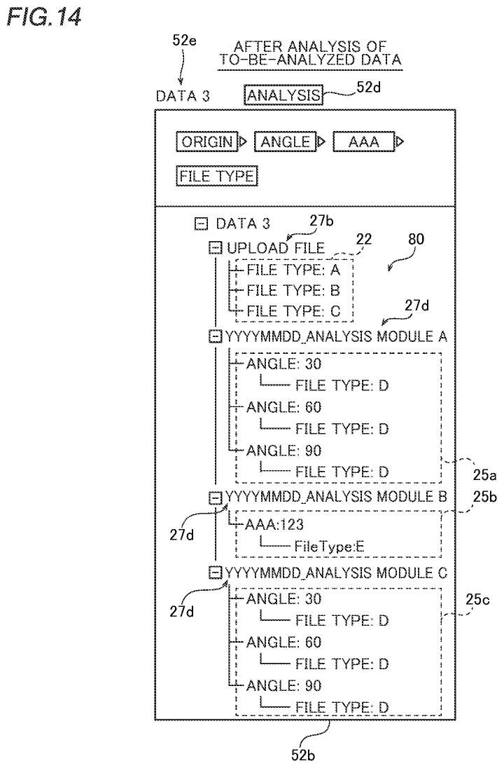

There is a need to further analyze the analysis results 25. In this embodiment, as shown in FIG. 14, the controller 12 is configured to direct the display 2a (see FIG. 1) to display the analysis results 25 that are linked with the top hierarchical data items 21 whose access rights are not provided to the user.

In this embodiment, the analyzer 12a (see FIG. 1) is configured to further analyze the analysis result 25 that is accepted as input data from the analysis results 25 that are displayed on the display 2a.

For example, in a case in which a user selects the analysis result 25a, and provides an instruction to execute analysis by using the analysis module 23c (see FIG. 5), the analyzer 12a analyzes the analysis result 25a by using the analysis module 23c so that an analysis result 25c shown in FIG. 14 is acquired. The controller 12 assigns the identifier 27 type 27c (see FIG. 12) and the value 27d to the analysis result 25c, and stores it in the storage 11.

The controller 12 to direct the display to display the analysis result 25c listed together with the to-be-analyzed data items 22a, analysis results 25a and analysis results 25b as shown in FIG. 14. In other words, when an analysis result 25 is acquired, the controller 12 attaches an identifier 27 indicating input data to the analysis result, stores the analysis result with the identifier into the storage 11, and updates the data tree 80 to be displayed in the to-be-analyzed data display area 52b. As a result, the to-be-analyzed data items 22, or a newly acquired analysis result 25 that is acquired when analysis is executed based on the analysis result 25 can be displayed in the data tree 80.

### <Analysis Result Storage Processing>

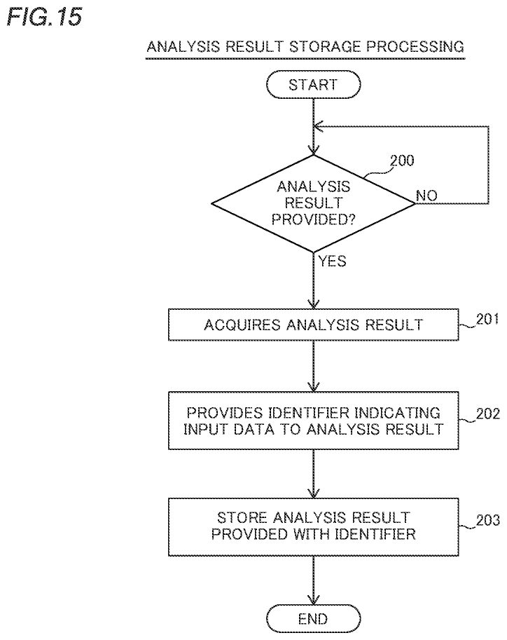

A configuration of the controller 12 (see FIG. 1) that attaches an identifier 27 (see FIG. 12) to an analysis result 25 (see FIG. 12), and stores the analysis result with the identifier into the storage 11 (see FIG. 12) is now described with reference to FIG. 15.

In step 200, the controller 12 determines whether the analysis result 25 is provided. If the analysis result 25 is not provided, the procedure repeats step 200. If the analysis result 25 is provided, the procedure goes to step 201.

In step 201, the analyzer 12a (see FIG. 12) acquires the analysis result 25.

In step 202, the ID provider 12c (see FIG. 12) provides the identifier 27 (see FIG. 12) indicating input data to the analysis result 25. Specifically, the ID provider 12c provides a type 27c (see FIG. 12) of the identifier 27 indicating input data, and a value 27d (see FIG. 12) based on an analysis data item and a name of an analysis module 23 used for analysis to the analysis result 25.

In step 203, the analysis result 25 provided with the identifier 27 including input data is stored into the storage 11 by the controller 12. In this embodiment, the controller 12 stores the analysis result 25, which is provided with the identifier 27 including input data, linked with a to-be-analyzed data item 22 or a top hierarchical data item 21 (see FIG. 1) with which the analysis result 25 is linked that is selected when the analysis is executed into the storage 11. After that, the procedure ends.

### <Analysis Result Display Processing>

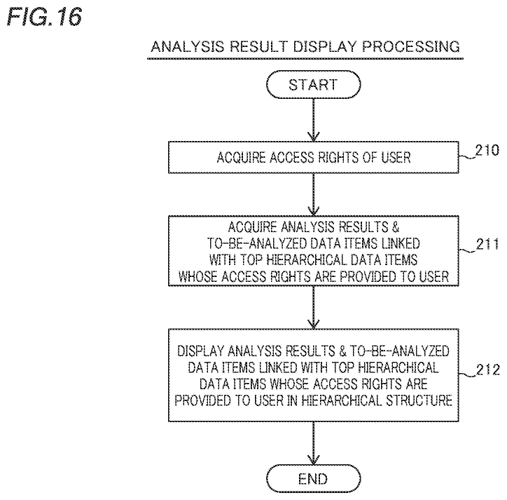

The following description describes control of the controller 12 (see FIG. 1) that directs the display 2a (see FIG. 1) to display analysis results 25 (see FIG. 13) in the hierarchical structure with reference to FIG. 16.

In step 210, the controller 12 acquires access rights of a user. A configuration of the controller 12 acquires access rights of a user is the same process as step 110 shown in FIG. 8, and its description is omitted.

In step 211, the controller 12 acquires the to-be-analyzed data items 22 and the analysis result 25 linked with top hierarchical data items 21 (see FIG. 1) whose whose access rights are provided to the user.

In step 212, the controller 12 directs the display to display the to-be-analyzed data items 22 and the analysis result 25 linked with the top hierarchical data items 21 whose whose access rights are provided to the user in the hierarchical structure. Specifically, the controller 12 produces a data tree 80 that includes the to-be-analyzed data items 22 and the analysis result 25 linked with the top hierarchical data items 21 whose whose access rights are provided to the user, and directs the display to display the data tree 80. After that, the procedure ends.

### Advantages of the Embodiment

In this embodiment, the following advantages are obtained.

In this embodiment, as described above, the data analysis system 100 is a data analysis system for displaying to-be-analyzed data items 22 as data to be analyzed in a hierarchical structure having a plurality of hierarchies and for analyzing the to-be-analyzed data items 22, and includes a data acquirer 10 configured to acquire the to-be-analyzed data items 22; a storage 11 configured to store the to-be-analyzed data items 22 and analysis modules 23 as programs to analyze the to-be-analyzed data items 22 linked with top hierarchical data items 21, which are data belonging to a top hierarchy of the hierarchical structure; an analyzer 12a configured to analyze the to-be-analyzed data items 22 by using the analysis modules 23; a display 2a configured to display the to-be-analyzed data items 22 and/or the analysis modules 23; and a controller 12 configured to direct the display 2a to display the to-be-analyzed data items 22 and/or the analysis modules 23 that are linked with the top hierarchical data items 21 whose access rights are provided to a user in the hierarchical structure from the to-be-analyzed data items 22 and the analysis modules 23 linked with the top hierarchical data items 21 that are stored in the storage 11, and to exclude the to-be-analyzed data items 22 and the analysis modules 23 that are linked with the top hierarchical data items 21 stored in the storage whose access rights are not provided to the user from items to be displayed on the display 2a.

Because the storage 11 is configured to store the to-be-analyzed data items 22 and the analysis modules 23 linked with top hierarchical data items 21, by providing each individual user with the access rights corresponding to the top hierarchical data items 21, access rights to the to-be-analyzed data items 22 and the analysis modules 23 that are linked with the top hierarchical data items 21 can be collectively provided to the user. Accordingly, it is possible to prevent complicated access right management of the to-be-analyzed data items 22 and the analysis modules 23. Also, the to-be-analyzed data items 22 and/or the analysis modules 23 whose access rights are provided to the user is displayed in the hierarchical structure from the to-be-analyzed data items 22 and the analysis modules 23 linked with the top hierarchical data items 21. Accordingly, even if a user is neither a person who acquires the to-be-analyzed data items 22 nor a a person who creates the analysis modules 23, the to-be-analyzed data items 22 and/or the analysis modules 23 whose access rights are provided to the user can be displayed for the user. As a result, a user can easily commonly use the to-be-analyzed data items 22 and the analysis modules 23 whose access rights are provided to the user. Therefore, it is possible to allow users to commonly use data to be used in analysis while preventing complicated access right management of the data to be used in analysis.

In this embodiment, as discussed above, the analysis data display apparatus 2 is an analysis data display apparatus for displaying to-be-analyzed data 22 as data to be analyzed in a hierarchical structure having a plurality of hierarchies, the analysis data display apparatus including a display 2a configured to display the to-be-analyzed data items 22 and/or analysis modules 23 as programs to analyze the to-be-analyzed data items 22 that are linked with top hierarchical data items 21 that are data belonging to a top hierarchy of the hierarchical structure, wherein the display 2a is configured to display the to-be-analyzed data items 22 and/or the analysis modules 23 that are linked with the top hierarchical data items 21 whose access rights are provided to a user in the hierarchical structure from the to-be-analyzed data items 22 and the analysis modules 23 linked with the top hierarchical data items 21, and to display neither the to-be-analyzed data items 22 nor the analysis modules 23 that are linked with the top hierarchical data items 21 whose access rights are not provided to the user.

Therefore, it is possible to provide an analysis data display apparatus 2 capable of allowing users to commonly use data to be used in analysis while preventing complicated access right management of the data to be used in analysis similar to the aforementioned data analysis system 100.

In this embodiment, as described above, a data display method in the data analysis system 100 is a data display method in a data analysis system for analyzing to-be-analyzed data items 22 as data to be analyzed displayed in a hierarchical structure having a plurality of hierarchies, and includes a step of acquiring the to-be-analyzed data items 22; a step of storing the to-be-analyzed data items 22 and analysis modules 23 as programs to analyze the to-be-analyzed data items 22 linked with top hierarchical data items 21, which are data belonging to a top hierarchy; a step of providing each individual user with the access rights corresponding to the top hierarchical data items 21; a step of acquiring the to-be-analyzed data items 22 and/or the analysis modules 23 whose access rights are provided to a user from the to-be-analyzed data items 22 and the analysis modules 23 linked with the top hierarchical data items 21, which have been stored, and a step of displaying the to-be-analyzed data items 22 and/or the analysis modules 23 whose access rights are provided to the user in the hierarchical structure on a display 2a.

Therefore, it is possible to provide a data display method in the data analysis system 100 capable of allowing users to commonly use data to be used in analysis while preventing complicated access right management of the data to be used in analysis similar to the aforementioned data analysis system 100.

In addition, following additional advantages can be obtained by the aforementioned embodiment added with configurations discussed below.

That is, in this embodiment, as discussed above, an access right provider 12b configured to provide each individual user with the access rights corresponding to a plurality of top hierarchical data items 21 is further included. Accordingly, it is possible to easily provides each individual user with the access rights corresponding to the plurality of top hierarchical data items 21.

In this embodiment, as discussed above, the display 2a includes a first display area 51 for displaying the top hierarchical data items 21; and the controller 12 is configured to direct the display to list the plurality of top hierarchical data items 21 whose access rights are provided to the user in the first display area 51, and to direct the display to list the to-be-analyzed data items 22 and/or the analysis modules 23 that are linked with the plurality of top hierarchical data items 21 that are displayed in the first display area 51. Accordingly, because the to-be-analyzed data items 22 and/or the analysis modules 23 that are linked with the plurality of top hierarchical data items 21 that are displayed in the first display area 51 is listed, the user can easily grasp the to-be-analyzed data items 22 and/or the analysis modules 23 corresponding to the plurality of top hierarchical data items 21 whose access rights are provided to the user. As a result, the user can easily grasp the to-be-analyzed data items 22 and/or the analysis modules 23 that are accessible and available to the user.

In this embodiment, as discussed above, the display 2a further includes a second display area 52 for displaying the to-be-analyzed data items 22 that are linked with the plurality of top hierarchical data items 21; and the controller 12 is configured to direct the display to list the to-be-analyzed data items 22 that are linked with the plurality of top hierarchical data items 21 that are displayed in the first display area 51 in the second display area 52. Accordingly, because the to-be-analyzed data items 22 that are linked with the plurality of top hierarchical data items 21 that are displayed in the first display area 51 are listed in the second display area 52, a user can easily grasp the to-be-analyzed data items 22 whose access rights are provided to the user. As a result, the user can easily grasp the to-be-analyzed data items 22 that are accessible and available to the user. Consequently, user usability can be improved.

In this embodiment, as discussed above, the hierarchical structure includes at least three hierarchies; the display 2a is configured to display the sub-hierarchical data items 26 that are data linked with the top hierarchical data items 21 and belong to a hierarchy one level lower than the top hierarchy, and the to-be-analyzed data items 22 in the second display area 52; and the controller 12 is configured to direct the display to list the sub-hierarchical data item 26 that are linked with the plurality of top hierarchical data items 21 that are displayed in the first display area 51 in the second display area 52. Accordingly, because the sub-hierarchical data item 26 that are linked with the plurality of top hierarchical data items 21 are listed in the second display area 52, a user can easily grasp the sub-hierarchical data item 26 whose access rights are provided to the user without individually confirming the sub-hierarchical data items 26 that are linked with the top hierarchical data items 21. As a result, as compared with a configuration in which in order to confirm the sub-hierarchical data item 26 that are linked with the top hierarchical data items 21, a user individually confirms the sub-hierarchical data item 26 whose access rights are provided to the user, it is possible to prevent the user's operation from becoming complicated.

In this embodiment, as discussed above, an input acceptor 2b configured to accept a user input instruction is further provided; the controller 12 is configured to direct the display to display an input field 52c for accepting the user input instruction in the second display area 52, and to narrow the to-be-analyzed data items 22 that are linked with the top hierarchical data items 21 to be displayed in the second display area 52 in accordance with the user input instruction accepted in the input field 52c. Accordingly, a user can enter a query in the input field 52c to narrow the to-be-analyzed data items to desired items whereby displaying the to-be-analyzed data item 22 that is desired by the user in the second display area 52. As a result, if the number of to-be-analyzed data items 22 that are linked with the plurality of top hierarchical data items 21 is large, because the to-be-analyzed data item 22 that are desired by a user can be displayed in the second display area 52, it is possible to prevent that visibility of the list of the to-be-analyzed data items 22 decreases.

In this embodiment, as discussed above, the controller 12 is configured to direct the display to display operating buttons 53 each of which switches, in accordance with the user input instruction accepted by the input acceptor 2b, between showing and hiding the to-be-analyzed data items 22 that are linked with one top hierarchical data item 21 in the plurality of top hierarchical data items 21 whose access rights are provided to the user in the first display area 51; and the operating buttons are aligned with the plurality of top hierarchical data items 21. Accordingly, the user can select whether to show the to-be-analyzed data items 22 that are linked with each top hierarchical data item 21 by individually switching the operating button corresponding to the top hierarchical data item 21. Consequently, user usability can be improved. Also, if the number of top hierarchical data items 21 whose access rights are provided to one user is large so that the number of to-be-analyzed data items 22 that are linked with the top hierarchical data items 21 is correspondingly large, visibility of a list of the to-be-analyzed data items 22 will reduce. To address this, according to the aforementioned configuration, the reduction of visibility of a list of the to-be-analyzed data items 22 can be prevented by hiding the to-be-analyzed data items 22 that are linked with the top hierarchical data items 21 that are not desired by the user.

In this embodiment, as discussed above, the display 2a further includes a third display area 55 for displaying the analysis modules 23; and the controller 12 is configured to direct the display to show the plurality of top hierarchical data items 21 whose access rights are provided to the user in the first display area 51, and to direct the display to list the set of the analysis modules 23 that are linked with the plurality of top hierarchical data items 21 displayed in the first display area 51 in the third display area 55. Accordingly, because the analysis modules 23 that are linked with the plurality of top hierarchical data items 21 that are displayed in the first display area 51 are listed in the third display area 55, a user can easily grasp the analysis modules 23 whose access rights are provided to the user. Because the user can easily grasp the analysis modules 23 that are accessible and available to the user, user usability can be improved.

In this embodiment, as discussed above, the controller 12 is configured, in a case in which one of the analysis modules 23 is linked with two or more of the top hierarchical data items 21, to direct the display 2a to display the one of the analysis modules 23 if all the access rights to the two or more of the top hierarchical data items 21 are provided to the user, and to exclude the one of the analysis modules 23 from the modules to be displayed on the display 2a if at least one of the access rights to the two or more of the top hierarchical data items 21 is not provided to the user. According to this configuration, because in a case in which one of the analysis modules 23 is linked with the two or more of the top hierarchical data items 21 if at least one of the access rights to the two or more of the top hierarchical data items 21 is not provided to the user the one of the analysis modules 23 is excluded from the modules to be displayed, access rights to the analysis modules 23 can be more strictly managed. As a result, because the analysis modules 23 can be used (shared) under the strict access right management, it is possible to more effectively prevent that confidential analysis modules 23 are used (shared) by users who do not have access rights to the confidential analysis modules.

In this embodiment, as discussed above, the storage 11 is configured to store analysis results 25, which are results of analysis of the to-be-analyzed data items 22 by the analysis modules 23, linked with the top hierarchical data items 21; and the controller 12 is configured to direct the display 2a to display the analysis results 25 that are linked with the top hierarchical data items 21 whose access rights are provided to the user from the analysis results 25 that are stored in the storage 11 in the hierarchical structure, and to exclude the analysis results 25 that are linked with the top hierarchical data items 21 whose access rights are not provided to the user from the analysis results to be displayed on the display 2a. According to this configuration, because the analysis results 25, which are results of analysis of the to-be-analyzed data items 22 whose access rights are provided to the user are displayed together with the to-be-analyzed data items 22 in the hierarchical structure on the display 2a, the user can confirm both the to-be-analyzed data items 22 and the analysis results 25 whose access rights are provided to the user. Consequently, user usability can be improved.

In this embodiment, as discussed above, the controller 12 is configured to direct the display 2a to display the analysis results 25 that are linked with the top hierarchical data items 21; and the analyzer 12a is configured to further analyze the analysis result 25 that is accepted as input data from the analysis results 25 that are displayed on the display 2a. Accordingly, the user can further analyze the analysis result 25 by selecting the analysis result 25 displayed on the display 2a.

Consequently, for example, as compared with a configuration in which a user uploads an analysis result 25 as input data, and the uploaded analysis result 25 is then analyzed, it is possible to prevent the user's operation processes from becoming complicated.

In this embodiment, as discussed above, the analysis module 23 includes a learned model 30 that has learned to analyze the to-be-analyzed data item 22; the storage 11 is configured to store the to-be-analyzed data items 22 and input teacher data items 24 to be used to generate the learned model 30 with an identifier 27 indicating the input data being attached to the to-be-analyzed data items 22 and input teacher data items 24; and the controller 12 is configured to direct the storage 11 to store the analysis results 25 as the input data by attaching the identifier 27 indicating the input data to the analysis results 25 similar to the to-be-analyzed data items 22 and the input teacher data items 24. According to this configuration, because the analysis results 25 is stored in the storage 11 as the input data by attaching the identifier 27 indicating the input data to the analysis results 25, it is possible to easily further analyze the analysis result 25 and/or easily generate the learned model 30 by using the analysis result 25.

In this embodiment, as discussed above, the controller 12 is configured to direct the display to list the to-be-analyzed data items 22 and/or the input teacher data items 24, and the analysis results 25 in a bottom hierarchy of the hierarchical structure. According to this configuration, because the to-be-analyzed data items 22 and/or the input teacher data items 24, and the analysis results 25 are listed, the analysis result 25 can be further analyzed or the learned model 30 by using the analysis result 25 can be generated by selecting one of the listed analysis results 25. Accordingly, because the to-be-analyzed data item and the input teacher data item for the learned model 30 can be selected based on the listed analysis results 25, user usability can be improved.

### Modified Embodiments

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

While the example in which the data analysis system 100 includes the access right provider 12b has been shown in the aforementioned embodiment, the present invention is not limited to this. For example, the data analysis system 100 may not include the access right provider 12b. In a case in which the data analysis system 100 does not include the access right provider 12b, access rights to the top hierarchical data items 21 can be provided to users by another information processing device. However, in the case in which the data analysis system 100 does not include the access right provider 12b, operation for providing access rights to the top hierarchical data items 21 to users becomes complicated. For this reason, the data analysis system 100 preferably includes the access right provider 12b.

While the example in which the controller 12 is configured to direct the display to display the screen 50 that shows the top hierarchical data items 21 in the first display area 51 and the to-be-analyzed data item 22 in the second display area 52, and the screen 54 that shows the top hierarchical data items 21 in the first display area 51 and the analysis modules 23 in the third display area 55 has been shown in the aforementioned embodiment, the present invention is not limited to this. For example, the controller 12 may be configured to direct the display to display the top hierarchical data items 21, the to-be-analyzed data items 22 and the analysis modules 23 in a common screen.

While the example in which the to-be-analyzed data items 22 are linked with the top hierarchical data items 21 through the sub-hierarchical data items 26, and the controller 12 directs the display to display the sub-hierarchical data items 26 in the second display area 52 has been shown in the aforementioned embodiment, the present invention is not limited to this. For example, the to-be-analyzed data items 22 may be directly linked with the top hierarchical data items 21. That is, the hierarchical structure may have two hierarchies. In this case, the controller 12 may direct the display to display only the to-be-analyzed data items 22 in the second display area 52 without the sub-hierarchical data items 26.

While the example in which one sub-hierarchical data item 26 is linked with one top hierarchical data item 21 has been shown in the aforementioned embodiment, the present invention is not limited to this. For example, the top hierarchical data item 21 may be configured to be linked with sub-hierarchical data items 26 including a plurality of hierarchies. That is, the hierarchical structure may have more than three hierarchies.

While the example in which the controller 12 is configured to direct the display to display the input field 52c for narrowing the to-be-analyzed data items 22 in the second display area 52 has been shown in the aforementioned embodiment, the present invention is not limited to this. For example, the controller 12 may not be configured to direct the display to display the input field 52c. In this case, the controller 12 may not be configured to narrow the to-be-analyzed data items 22 to be displayed in the second display area 52. However, in a case in which the controller 12 is not configured to direct the display to display the input field 52c, the to-be-analyzed data items 22 to be displayed in the second display area 52 cannot be narrowed. In a case in which the number of to-be-analyzed data items 22 increases, if the to-be-analyzed data items 22 to be displayed in the second display area 52 cannot be narrowed, visibility of the list of the to-be-analyzed data items 22 decreases. For this reason, the controller 12 is preferably configured to direct the display to display the input field 52c for narrowing the to-be-analyzed data items 22 in the second display area 52.

While the example in which the controller 12 is configured to direct the display to display the operating buttons 53 for switching between showing and hiding the to-be-analyzed data items 22 linked with the plurality of top hierarchical data items 21 in the first display area 51 has been shown in the aforementioned embodiment, the present invention is not limited to this. For example, the controller 12 may not be configured to direct the display to display the operating buttons 53. However, in a case in which the controller 12 is not be configured to direct the display to display the operating buttons 53, the to-be-analyzed data items 22 linked with the plurality of top hierarchical data items 21 cannot be switched between showing and hiding. In this case, if the number of to-be-analyzed data items 22 is large, visibility of the list of the to-be-analyzed data items 22 in the second display area 52 decreases. For this reason, the controller 12 is preferably configured to direct the display to display the operating buttons 53 for switching between showing and hiding the to-be-analyzed data items 22 linked with the plurality of top hierarchical data items 21 in the first display area 51.

While the example in which the controller 12 is configured to direct the display to display the operating buttons 56 for switching between showing and hiding the analysis modules 23 linked with the plurality of top hierarchical data items 21 in the first display area 51 has been shown in the aforementioned embodiment, the present invention is not limited to this. For example, the controller 12 may not be configured to direct the display to display the operating buttons 56. However, in a case in which the controller 12 is not be configured to direct the display to display the operating buttons 56, the analysis modules 23 linked with the plurality of top hierarchical data items 21 cannot be switched between showing and hiding. In this case, if the number of analysis modules 23 is large, visibility of the list of the analysis modules 23 in the third display area 55 decreases. For this reason, the controller 12 is preferably configured to direct the display to display the operating buttons 56 for switching between showing and hiding the analysis modules 23 linked with the plurality of top hierarchical data items 21 in the first display area 51.

While the example in which the controller 12 is configured to store the analysis results 25 linked with the top hierarchical data items 21 has been shown in the aforementioned embodiment, the present invention is not limited to this. The controller 12 may not be configured to store the analysis results 25 linked with the top hierarchical data items 21. However, in a case in which the controller 12 is not be configured to store the analysis results 25 linked with the top hierarchical data items 21, the controller 12 cannot direct the display to list the analysis results 25 together with the to-be-analyzed data items 22. For this reason, the controller 12 is preferably configured to store the analysis results 25 linked with the top hierarchical data items 21

While the example in which the analyzer 12a can further analyze the analysis result 25 has been shown in the aforementioned embodiment, the present invention is not limited to this. For example, the analyzer 12a may not further analyze the analysis result 25. However, in a case in which the analyzer 12a is not configured to further analyze the analysis result 25, even if a user desires to further analyze the analysis result 25, the user cannot further analyze the analysis result 25, and as a result user usability decreases. For this reason, the analyzer 12a is preferably configured to further analyze the analysis result 25.

While the example in which the analysis results 25 are stored as input data by the controller 12 has been shown in the aforementioned embodiment, the present invention is not limited to this. For example, the analysis results 25 may not be stored as input data by the controller 12. However, in a case in which the analysis results 25 are not stored as input data by the controller 12, users are required to upload the analysis results 25 as input data or to perform another operating procedure to further analyze the analysis results 25. Such a procedure places burdens on the users. For this reason, the analysis results 25 are preferably stored as input data by the controller 12.

While the example in which the controller 12 is configured to direct the display to list the to-be-analyzed data items 22 and the analysis results 25 in the bottom hierarchy of the hierarchical structure has been shown in the aforementioned embodiment, the present invention is not limited to this. For example, the controller 12 may be configured to direct the display to list the input teacher data items 24 and the analysis results 25 in the bottom hierarchy of the hierarchical structure.

While the example in which the controller 12 (analyzer 12a) is configured to analyze the to-be-analyzed data items 22 or to further analyze analysis results 25 has been shown in the aforementioned embodiment, the present invention is not limited to this. For example, the controller 12 may be configured to generate learned models 30 that learn to analysis by using the input teacher data items 24 or the analysis results 25.

While the example in which the ID provider 12c is configured to attaches the same type 27c of the identifier 27 as the type 27a of the to-be-analyzed data item 22 to the analysis result 25 has been shown in the aforementioned embodiment, the present invention is not limited to this. The type 27c of the identifier 27 attached to the analysis result 25 by the ID provider 12c may not be the same as the type 27a of the identifier 27 of the to-be-analyzed data item 22 if the type 27c of the identifier 27 indicates input data, for example.

While the example in which the operating button 53 is displayed to switch between showing and hiding the to-be-analyzed data item 22 in accordance with a position of the button part 60 by the controller 12 has been shown in the aforementioned embodiment, the present invention is not limited to this. For example, a check box may be displayed by the controller 12 instead of the operating button 53. In a case of a configuration in which a check box is displayed, the controller 12 can be configured to direct the display to switch between showing and hiding the to-be-analyzed data item 22 in accordance with whether the check box is marked. Also, the controller 12 may be configured to display showing and hiding buttons for showing and hiding the to-be-analyzed data item 22. The controller 12 may be configured to display any operating part as long as the operating part allows users to switch between showing and hiding the to-be-analyzed data item 22. The same goes for the operating button 56 displayed by the controller 12.

While the example in which the data analysis system 100 is constructed of a client-server model has been shown in the aforementioned embodiment, the present invention is not limited to this. For example, the data analysis system 100 may be constructed of an independent computer.

### Modes

The aforementioned exemplary embodiment will be understood as concrete examples of the following modes by those skilled in the art.

### (Mode Item 1)

A data analysis system according to a mode item 1 is a data analysis system for displaying to-be-analyzed data items as data to be analyzed in a hierarchical structure having a plurality of hierarchies and for analyzing the to-be-analyzed data items, the data analysis system comprising: a data acquirer configured to acquire the to-be-analyzed data items; a storage configured to store the to-be-analyzed data items and analysis modules as programs to analyze the to-be-analyzed data items linked with top hierarchical data items that are data belonging to a top hierarchy of the hierarchical structure; an analyzer configured to analyze the to-be-analyzed data items by using the analysis modules; a display configured to display the to-be-analyzed data items and/or the analysis modules; and a controller configured to direct the display to display the to-be-analyzed data items and/or the analysis modules that are linked with the top hierarchical data item (s) whose access right (s) is/are provided to a user in the hierarchical structure from the to-be-analyzed data items and the analysis modules linked with the top hierarchical data item(s) that is/are stored in the storage, and to exclude the to-be-analyzed data items and the analysis modules that are linked with the top hierarchical data item(s) stored in the storage whose access right (s) is/are not provided to the user from items to be displayed on the display.

### (Mode Item 2)

In the data analysis system according to mode item 1, an access right provider configured to provide each individual user with the access rights corresponding to a plurality of top hierarchical data items as the top hierarchical data item(s) is further provided.

### (Mode Item 3)

In the data analysis system according to mode item 1 or 2, the display includes a first display area for displaying the plurality of top hierarchical data items; and the controller is configured to direct the display to list the plurality of top hierarchical data items whose access rights are provided to the user in the first display area, and to direct the display to list the to-be-analyzed data items and/or the analysis modules that are linked with the plurality of top hierarchical data items that are displayed in the first display area.

### (Mode Item 4)

In the data analysis system according to mode item 3, the display includes a second display area for displaying the to-be-analyzed data items that are linked with the top hierarchical data items; and the controller is configured to direct the display to list the to-be-analyzed data items that are linked with the plurality of top hierarchical data items that are displayed in the first display area in the second display area.

### (Mode Item 5)

In the data analysis system according to mode item 4, the hierarchical structure includes at least three hierarchies; the display is configured to display sub-hierarchical data items that are data linked with the top hierarchical data items and belong to a hierarchy one level lower than the top hierarchy in the second display area; and the controller is configured to direct the display to list the sub-hierarchical data items that are linked with the plurality of top hierarchical data items that are displayed in the first display area in the second display area.

### (Mode Item 6)

In the data analysis system according to mode item 5, an input acceptor configured to accept a user input instruction is further provided; and the controller is configured to direct the display to display an input field for accepting the user input instruction in the second display area, and to narrow the to-be-analyzed data items that are linked with the top hierarchical data items to be displayed in the second display area in accordance with the user input instruction accepted in the input field.

### (Mode Item 7)

In the data analysis system according to mode item 6, the controller is configured to direct the display to display operating buttons each of which switches, in accordance with the user input instruction accepted by the input acceptor, between showing and hiding the to-be-analyzed data item(s) that is/are linked with one top hierarchical data item in the plurality of top hierarchical data items whose access rights are provided to the user in the first display area; and the operating buttons are aligned with the plurality of top hierarchical data items.

### (Mode Item 8)

In the data analysis system according to any of mode items 3 to 7, the display further includes a third display area for displaying the analysis modules; and the controller is configured to direct the display to display the plurality of top hierarchical data items whose access rights are provided to the user in the first display area, and to direct the display to list the analysis modules that are linked with the plurality of top hierarchical data items that are displayed in the first display area in the third display area.

### (Mode Item 9)

In the data analysis system according to any of mode items 1 to 8, the controller is configured, in a case in which one of the analysis modules is linked with two or more of the top hierarchical data items, to direct the display to display the one of the analysis modules if all the access rights to the two or more of the top hierarchical data items are provided to the user, and to exclude the one of the analysis modules from the modules to be displayed on the display if at least one of the access rights to the two or more of the top hierarchical data items is not provided to the user.

### (Mode Item 10)

In the data analysis system according to any of mode items 1 to 9, the storage is configured to store analysis results, which are results of analysis of the to-be-analyzed data items by the analysis modules, linked with the top hierarchical data items; and the controller is configured to direct the display to display the analysis result (s) that is/are linked with the top hierarchical data items whose access rights are provided to the user from the analysis results that are stored in the storage in the hierarchical structure, and to exclude the analysis result (s) that is/are linked with the top hierarchical data items whose access rights are not provided to the user from the analysis result (s) to be displayed on the display.

### (Mode Item 11)

In the data analysis system according to mode item 10, the controller is configured to direct the display to display the analysis result (s) that is/are linked with the top hierarchical data items; and the analyzer is configured to further analyze the analysis result that is accepted as input data from the analysis result (s) that is/are displayed on the display.

### (Mode Item 12)

In the data analysis system according to mode item 11, the analysis modules include a learned model that has learned to analyze the to-be-analyzed data item(s); the storage is configured to store the to-be-analyzed data items and input teacher data items to be used to generate the learned model with an identifier indicating the input data being attached to the to-be-analyzed data items and the input teacher data items; and the controller is configured to direct the storage to store the analysis results as the input data by attaching the identifier indicating the input data to the analysis results similar to the to-be-analyzed data items and the input teacher data items.

### (Mode Item 13)

In the data analysis system according to mode item 12, the controller is configured to direct the display to list the to-be-analyzed data items and/or the input teacher data items, and the analysis results in a bottom hierarchy of the hierarchical structure.

### (Mode Item 14)

An analysis data display apparatus according to a mode item 14 is an analysis data display apparatus for displaying to-be-analyzed data items as data to be analyzed in a hierarchical structure having a plurality of hierarchies, the analysis data display apparatus including a display configured to display the to-be-analyzed data items and/or analysis modules as programs to analyze the to-be-analyzed data items that are linked with top hierarchical data items that are data belonging to a top hierarchy of the hierarchical structure, wherein the display is configured to display the to-be-analyzed data items and/or the analysis modules that are linked with the top hierarchical data item (s) whose access right (s) is/are provided to a user in the hierarchical structure from the to-be-analyzed data items and the analysis modules that are linked with the top hierarchical data items, and to display neither the to-be-analyzed data items nor the analysis modules that are linked with the top hierarchical data item (s) whose access right (s) is/are not provided to the user.

### (Mode Item 15)

A data display method according to a mode item 15 is a data display method in a data analysis system for analyzing to-be-analyzed data items as data to be analyzed displayed in a hierarchical structure having a plurality of hierarchies, the data display method including a step of acquiring the to-be-analyzed data items; a step of storing the to-be-analyzed data items and analysis modules as programs to analyze the to-be-analyzed data items linked with top hierarchical data items that are data belonging to a top hierarchy; a step of providing each individual user with the access rights corresponding to the top hierarchical data item(s); a step of acquiring the to-be-analyzed data items and/or the analysis modules whose access right (s) is/are provided to a user from the to-be-analyzed data items and the analysis modules linked with the top hierarchical data items, which have been stored; and a step of displaying the to-be-analyzed data items and/or the analysis modules whose access rights are provided to the user in the hierarchical structure on a display.

What is claimed is:

1. A data analysis system for displaying to-be-analyzed data items as data to be analyzed in a hierarchical structure having a plurality of hierarchies and for analyzing the to-be-analyzed data items, the data analysis system comprising:
a data acquirer configured to acquire the to-be-analyzed data items;
a storage configured to store the to-be-analyzed data items and analysis modules as programs to analyze the to-be-analyzed data items linked with top hierarchical data items that are data belonging to a top hierarchy of the hierarchical structure;
an analyzer configured to analyze the to-be-analyzed data items by using the analysis modules;
a display configured to display the to-be-analyzed data items and/or the analysis modules; and
a controller configured to direct the display to display the to-be-analyzed data items and/or the analysis modules that are linked with the top hierarchical data item (s) whose access right (s) is/are provided to a user in the hierarchical structure from the to-be-analyzed data items and the analysis modules linked with the top hierarchical data item(s) that is/are stored in the storage, and to exclude the to-be-analyzed data items and the analysis modules that are linked with the top hierarchical data item(s) stored in the storage whose access right (s) is/are not provided to the user from items to be displayed on the display.

2. The data analysis system according to claim 1 further comprising an access right provider configured to provide each individual user with the access rights corresponding to a plurality of top hierarchical data items as the top hierarchical data item (s).

3. The data analysis system according to claim 2, wherein
the display includes a first display area for displaying the plurality of top hierarchical data items; and
the controller is configured to direct the display to list the plurality of top hierarchical data items whose access rights are provided to the user in the first display area, and to direct the display to list the to-be-analyzed data items and/or the analysis modules that are linked with the plurality of top hierarchical data items that are displayed in the first display area.

4. The data analysis system according to claim 3, wherein
the display includes a second display area for displaying the to-be-analyzed data items that are linked with the top hierarchical data items; and
the controller is configured to direct the display to list the to-be-analyzed data items that are linked with the plurality of top hierarchical data items that are displayed in the first display area in the second display area.

5. The data analysis system according to claim 4, wherein
the hierarchical structure includes at least three hierarchies;
the display is configured to display sub-hierarchical data items that are data linked with the top hierarchical data items and belong to a hierarchy one level lower than the top hierarchy in the second display area; and
the controller is configured to direct the display to list the sub-hierarchical data items that are linked with the plurality of top hierarchical data items that are displayed in the first display area in the second display area.

6. The data analysis system according to claim 5 further comprising
an input acceptor configured to accept a user input instruction, wherein
the controller is configured to direct the display to display an input field for accepting the user input instruction in the second display area, and to narrow the to-be-analyzed data items that are linked with the top hierarchical data items to be displayed in the second display area in accordance with the user input instruction accepted in the input field.

7. The data analysis system according to claim 6, wherein the controller is configured to direct the display to display operating buttons each of which switches, in accordance with the user input instruction accepted by the input acceptor, between showing and hiding the to-be-analyzed data item(s) that is/are linked with one top hierarchical data item in the plurality of top hierarchical data items whose access rights are provided to the user in the first display area; and the operating buttons are aligned with the plurality of top hierarchical data items.

8. The data analysis system according to claim 3, wherein
the display further includes a third display area for displaying the analysis modules; and
the controller is configured to direct the display to display the plurality of top hierarchical data items whose access rights are provided to the user in the first display area, and to direct the display to list the analysis modules that are linked with the plurality of top hierarchical data items that are displayed in the first display area in the third display area.

9. The data analysis system according to claim 1,
wherein the controller is configured, in a case in which one of the analysis modules is linked with two or more of the top hierarchical data items, to direct the display to display the one of the analysis modules if all the access rights to the two or more of the top hierarchical data items are provided to the user, and to exclude the one of the analysis modules from the modules to be displayed on the display if at least one of the access rights to the two or more of the top hierarchical data items is not provided to the user.

10. The data analysis system according to claim 1, wherein
the storage is configured to store analysis results, which are results of analysis of the to-be-analyzed data items by the analysis modules, linked with the top hierarchical data items; and
the controller is configured to direct the display to display the analysis result (s) that is/are linked with the top hierarchical data items whose access rights are provided to the user from the analysis results that are stored in the storage in the hierarchical structure, and to exclude the analysis result (s) that is/are linked with the top hierarchical data items whose access rights are not provided to the user from the analysis result (s) to be displayed on the display.

11. The data analysis system according to claim 10, wherein
the controller is configured to direct the display to display the analysis result (s) that is/are linked with the top hierarchical data items; and
the analyzer is configured to further analyze the analysis result that is accepted as input data from the analysis result (s) that is/are displayed on the display.

12. The data analysis system according to claim 11, wherein
the analysis modules include a learned model that has learned to analyze the to-be-analyzed data item (s);
the storage is configured to store the to-be-analyzed data items and input teacher data items to be used to generate the learned model with an identifier indicating the input data being attached to the to-be-analyzed data items and the input teacher data items; and
the controller is configured to direct the storage to store the analysis results as the input data by attaching the identifier indicating the input data to the analysis results similar to the to-be-analyzed data items and the input teacher data items.

13. The data analysis system according to claim 12, wherein the controller is configured to direct the display to list the to-be-analyzed data items and/or the input teacher data items, and the analysis results in a bottom hierarchy of the hierarchical structure.

14. An analysis data display apparatus for displaying to-be-analyzed data items as data to be analyzed in a hierarchical structure having a plurality of hierarchies, the analysis data display apparatus comprising:
a display configured to display the to-be-analyzed data items and/or analysis modules as programs to analyze the to-be-analyzed data items that are linked with top hierarchical data items that are data belonging to a top hierarchy of the hierarchical structure, wherein
the display is configured to display the to-be-analyzed data items and/or the analysis modules that are linked with the top hierarchical data item (s) whose access right (s) is/are provided to a user in the hierarchical structure from the to-be-analyzed data items and the analysis modules that are linked with the top hierarchical data items, and to display neither the to-be-analyzed data items nor the analysis modules that are linked with the top hierarchical data item(s) whose access right (s) is/are not provided to the user.

15. A data display method in a data analysis system for analyzing to-be-analyzed data items as data to be analyzed displayed in a hierarchical structure having a plurality of hierarchies, the data display method comprising:
a step of acquiring the to-be-analyzed data items;
a step of storing the to-be-analyzed data items and analysis modules as programs to analyze the to-be-analyzed data items linked with top hierarchical data items that are data belonging to a top hierarchy;
a step of providing each individual user with the access rights corresponding to the top hierarchical data item (s);
a step of acquiring the to-be-analyzed data items and/or the analysis modules whose access right (s) is/are provided to a user from the to-be-analyzed data items and the analysis modules linked with the top hierarchical data items, which have been stored; and
a step of displaying the to-be-analyzed data items and/or the analysis modules whose access rights are provided to the user in the hierarchical structure on a display.
